(19) United States
(12) Patent Application Publication
(10) Pub. No.: US 2018/0307039 A1
(43) Pub. Date: Oct. 25, 2018

(54) High Power Handling Optical Spatial Light Modulator

(71) Applicant: SILICON LIGHT MACHINES CORPORATION, Sunnyvale, CA (US)

(72) Inventors: Alexander Payne, Ben Lomond, CA (US); James Hunter, Campbell, CA (US); Lars Eng, Los Altos, CA (US); Sae Won Lee, Santa Clara, CA (US)

(21) Appl. No.: 16/010,148

(22) Filed: Jun. 15, 2018

Related U.S. Application Data
(63) Continuation-in-part of application No. 15/297,047, filed on Oct. 18, 2016.
Application No. 15/297,047 is a continuation-in-part of application No. 14/673,276, filed on Mar. 30, 2015, now abandoned.
(60) Provisional application No. 61/201,887, filed on Dec. 16, 2008.

(51) Int. Cl. G02B 26/08; G02B 5/08

(52) U.S. Cl. CPC G02B 26/0841; G02B 5/0833

(57) ABSTRACT

A high power handling optical modulator and methods of fabricating the same are described. The method includes forming a number of electrostatically deflectable elements over a surface of a substrate, and forming a non-metallic, multilayer optical reflector over each electrostatically deflectable element. The multilayer optical reflector includes at least a first layer of high index material having a high index of refraction, a second layer of a low index material having a low index of refraction formed over the first layer, and a third layer of high index material also having a high index of refraction formed over the second layer. Generally, the high index materials and low index material are selected and deposited to maintain planarity of the multilayer optical reflector at operating temperature. In one embodiment, the high and low index materials include silicon-germanium and air respectively. Other embodiments are also described.

### CROSS-REFERENCE TO RELATED APPLICATIONS

This application is a continuation-in-part of co-pending U.S. application Ser. No. 15/297,047, filed Oct. 18, 2016, which is a continuation-in-part of Ser. No. 14/673,276, filed Mar. 30, 2015, now abandoned, which claims the benefit of priority under 35 U.S.C. 119(e) to U.S. Provisional Patent Application Ser. No. 61/201,887, filed Sep. 22, 2014, all of which applications are hereby incorporated by reference in their entirety.

### TECHNICAL FIELD

The present invention relates generally to a Micro-Electromechanical System (MEMS)-based optical modulators with distributed mirrors for high power handling and to methods of manufacturing and using the same.

### BACKGROUND

Laser processing systems are widely used and growing in popularity for a number of different applications including cutting, marking, engraving, printing, testing and measuring. For example, laser engraving and imaging systems are used to form designs, such as text, logos, or other ornamental designs, on and/or in workpieces. Current state-of-art laser processing systems use a high power laser and a galvo-scan mirror to scan a single beam over a metal, plastic, wood or paper workpiece to form a design. Because of this the time required to form a design on a single workpiece using a conventional laser processing system is unacceptably long. Moreover, because in many conventional systems the workpiece is moved relative to the single laser beam the resolution and complexity of the design can be adversely affected.

MEMS-based spatial light modulators offer the prospect of greatly improved throughput over single-beam laser write systems. While it is desirable to use MEMS-based spatial light modulators in conjunction with high-power continuous wave (CW), nano-, pico-, and femto-second lasers, a variety of damage mechanisms preclude reliable operation with high-fluence applications. For CW and nano-second lasers, thermal degradation modes dominate. For example, in the “Soret effect”, atoms of a reflector material physically migrate from hotter regions to cooler regions, reducing the reflection efficiency of the SLM and accelerating further damage. For pico- and femto-second lasers, ablative damage modes dominate. Here, the peak pulse energies vaporize or otherwise degrade the reflector material. Both the thermal and ablative damage mechanism hinge on the reflectivity of the light-reflecting layer of the MEMS-based SLM. If the reflectivity is high enough, only minimal laser energy is transmitted to the mirror and MEMS structure. Accordingly, there is a need for enhanced reflectivity MEMS light modulators to enable the next generations of high-power laser processing systems.

### SUMMARY

In a first aspect, a method for fabricating a MEMS-based high power handling optical spatial light modulator (SLM) modulator is provided. The method includes or involves forming a number of electrostatically deflectable elements over a surface of a substrate, each electrostatically deflectable element including a mechanical layer and an electrode layer, followed by forming a non-metallic, multilayer optical reflector over each electrostatically deflectable element. The multilayer optical reflector includes at least a first layer of high index material having a high index of refraction, a second layer of a low index material having a low index of refraction formed over the first layer, and a third layer of high index material having a high index of refraction formed over the second layer. At a minimum, the high index and low index materials are selected and deposited to ensure that the overall stress stays tensile. Generally, the high index materials and low index material are selected and deposited to maintain planarity of the multilayer optical reflector at operating temperature. In one embodiment, the high index materials include silicon-germanium, and the low index material is air or an air-gap formed between the first and third layers of the high index materials.

In a second aspect a MEMS-based high power handling optical spatial light modulator (SLM) modulator is provided including a number of electrostatically deflectable elements suspended over a surface of a substrate, and a non-metallic, multilayer optical reflector over each electrostatically deflectable element. Each electrostatically deflectable element includes a mechanical layer and an electrode layer. The multilayer optical reflector includes at least a first layer including a first high index material having a high index of refraction, a second layer including a low index material having a low index of refraction formed over the first layer, and a third layer including a second high index material having a high index of refraction formed over the second layer. In some embodiments, the mechanical layer includes a tensile silicon-germanium, and the first and second high index materials and the low index material are selected and deposited to maintain planarity of the multilayer optical reflector at operating temperature. Suitable materials for the first and second high index materials can include monocrystalline silicon (Si), poly-crystalline silicon, amorphous silicon, silicon-nitride (SiN), silicon-germanium (SiGe), silicon-carbide, titanium-oxide (TiO₂) or zirconium-oxide (ZrO₂). Suitable low index materials having a low index of refraction (n) include silicon-dioxide (SiO₂), silicon-nitride, germanium, air or a MEMS fill gas, such as a mixture of one or more of nitrogen, hydrogen, helium, argon, krypton or xenon gases.

### BRIEF DESCRIPTION OF THE DRAWINGS

Embodiments of the present invention will be understood more fully from the detailed description that follows and from the accompanying drawings and the appended claims provided below, where:

FIG. 1A is a perspective view of an embodiment of a Micro-Electromechanical System (MEMS)-based optical modulator according to an embodiment of the present disclosure;

FIGS. 1B and 1C schematic block diagrams of sectional side views of the MEMS-based optical modulator of FIG. 1A;

FIG. 2A is a schematic block diagram of another embodiment of a MEMS based optical modulator according to an embodiment of the present disclosure;

FIG. 2B is a schematic sectional side view of two adjacent modulators of the array of FIG. 2A;

FIG. 2C is a schematic block diagram of an actuator of a single modulator of the array of FIG. 2A;

FIG. 3 is a schematic block diagram of a sectional side of a Planar Light Valve (PLV™) in which the distributed mirrors or reflectors are decoupled or mechanically isolated from the MEMS of the PLV™;

FIGS. 4A and 4B are schematic sectional side view of a stack of layers in a distributed or Bragg mirror for use in the MEMS-based optical modulator of FIGS. 1 through 3;

FIG. 5 is a graph illustrating the reflection, transmission and absorption of a distributed mirror including alternating layers of silicon-dioxide and poly-crystalline silicon at near-infrared (NIR) wavelengths;

FIG. 6 is a table giving the lowest absorption (k), and greatest index difference (n) and percent reflectance of different materials for use in a distributed mirror in the ultraviolet (UV), visible (VIS) and near infrared (NIR) wavelengths;

FIG. 7 is a graph illustrating the reflection, transmission and absorption of a silicon-nitride/silicon-dioxide distributed mirror in the ultraviolet (UV) wavelengths;

FIG. 8 is a graph illustrating the reflection, transmission and absorption of a zirconium-oxide/silicon-dioxide distributed mirror in the ultraviolet (UV) wavelengths;

FIG. 9 is a graph illustrating the reflection, transmission and absorption of a silicon-carbide/silicon-dioxide distributed mirror in the ultraviolet (UV) wavelengths;

FIG. 10 is a graph illustrating the reflection, transmission and absorption of a silicon-nitride/silicon-dioxide distributed mirror in the visible (VIS) wavelengths;

FIG. 11 is a graph illustrating the reflection, transmission and absorption of a silicon-carbide/silicon-dioxide distributed mirror in the visible (VIS) wavelengths;

FIG. 12 is a graph illustrating the reflection, transmission and absorption of a titanium-oxide/silicon-dioxide distributed mirror in the visible (VIS) wavelengths;

FIG. 13 is a graph illustrating the reflection, transmission and absorption of an aluminum-arsenide/silicon-dioxide distributed mirror in the visible (VIS) wavelengths;

FIG. 14 is a graph illustrating the reflection, transmission and absorption of a titanium-oxide/silicon-dioxide distributed mirror in the near infrared (NIR) wavelengths;

FIG. 15 is a graph illustrating the reflection, transmission and absorption of an aluminum-arsenide/silicon-dioxide distributed mirror in the near infrared (NIR) wavelengths;

FIG. 16 is a graph illustrating the reflection, transmission and absorption of a poly-crystalline silicon/silicon-dioxide distributed mirror in the near infrared (NIR) wavelengths and having a thickness of 4480 angstroms (Å);

FIG. 17 is a graph illustrating the reflection, transmission and absorption of a poly-crystalline silicon/silicon-dioxide distributed mirror in the near infrared (NIR) wavelengths and having a thickness of 2500 Å;

FIGS. 18A and 18B are schematic sectional side view of a stack of layers in a distributed (Bragg) mirrors including or overlying an aluminum absorbing layer for use in the MEMS-based optical modulator of FIGS. 1A through 3;

FIG. 19 is a graph illustrating the reflection, transmission and absorption in the ultraviolet (UV) wavelengths of a Bragg mirror including a stack of silicon-carbide/silicon-dioxide reflective layers overlying a metal containing layer;

FIG. 20 is a schematic block diagram of an embodiment of a laser processing system including an array of optical modulators with distributed mirrors for high power handling according to an embodiment of the present disclosure;

FIG. 21 is a schematic block diagram of another embodiment of a laser processing system using phase modulation including an array of optical modulators with distributed mirrors for high power handling according to an embodiment of the present disclosure;

FIG. 22 is a flowchart illustrating an embodiment of a method for processing a workpiece using the laser processing systems of FIG. 20 or 21;

FIG. 23 is a schematic block diagram of an additive three-dimensional (3D) printing system including an array of optical modulators with distributed mirrors for high power handling according to an embodiment of the present disclosure;

FIG. 24 is a schematic block diagrams of a Planar Light Valve (PLV™) modulator having a non-metallic, multilayer optical reflector;

FIG. 25 is a schematic sectional side view of a stack of layers in a non-metallic, multilayer optical reflector including solid, low index material layers for use in the MEMS-based optical modulator according to an embodiment of the present disclosure;

FIG. 26 is a schematic sectional side view of a stack of layers in a non-metallic, multilayer optical reflector including air gaps for use in the MEMS-based optical modulator according to another embodiment of the present disclosure;

FIG. 27 is a graph illustrating the reflection, transmission and absorption of a non-metallic reflector including multiple interleaved silicon-germanium layers and air-gaps; and

FIGS. 28A and 28B are a flowchart illustrating an embodiment of a method for fabricating an optical modulator including a non-metallic, multilayer optical reflector.

### DETAILED DESCRIPTION

Embodiments of laser processing systems including a Micro-Electromechanical System (MEMS) devices based optical switch or optical modulator with distributed mirrors for high power handling and to methods of manufacturing and using the same are described herein with reference to figures. However, particular embodiments may be practiced without one or more of these specific details, or in combination with other known methods, materials, and apparatuses. In the following description, numerous specific details are set forth, such as specific materials, dimensions and processes parameters etc. to provide a thorough understanding of the present invention. In other instances, well-known semiconductor design and fabrication techniques have not been described in particular detail to avoid unnecessarily obscuring the present invention. Reference throughout this specification to “an embodiment” means that a particular feature, structure, material, or characteristic described in connection with the embodiment is included in at least one embodiment of the invention. Thus, the appearances of the phrase “in an embodiment” in various places throughout this specification are not necessarily referring to the same embodiment of the invention. Furthermore, the particular features, structures, materials, or characteristics may be combined in any suitable manner in one or more embodiments.

The terms “over,” “under,” “between,” and “on” as used herein refer to a relative position of one layer with respect to other layers. As such, for example, one layer deposited or disposed over or under another layer may be directly in contact with the other layer or may have one or more intervening layers. Moreover, one layer deposited or disposed between layers may be directly in contact with the layers or may have one or more intervening layers. In contrast, a first layer “on” a second layer is in contact with that second layer. Additionally, the relative position of one layer with respect to other layers is provided assuming operations deposit, modify and remove films relative to a starting substrate without consideration of the absolute orientation of the substrate.

The optical modulator can be either a binary optical switch in which the reflectance is switched between high and low states, or an analog optical modulator with gray scale capability in which either the phase or intensity of light reflected from the optical modulator can be continuously modulated.

Furthermore, the optical modulator can include either a single, individual pixel or multiple pixels ganged together in a one-dimensional (1D) or two-dimensional (2D) array to create a high power spatial light modulator (SLM). Suitable optical modulators include a ribbon-type optical modulator, such as a Grating Light Valve (GLV™), or a Planar Light Valve (PLV™), from Silicon Light Machines, Inc., of Sunnyvale, Calif.

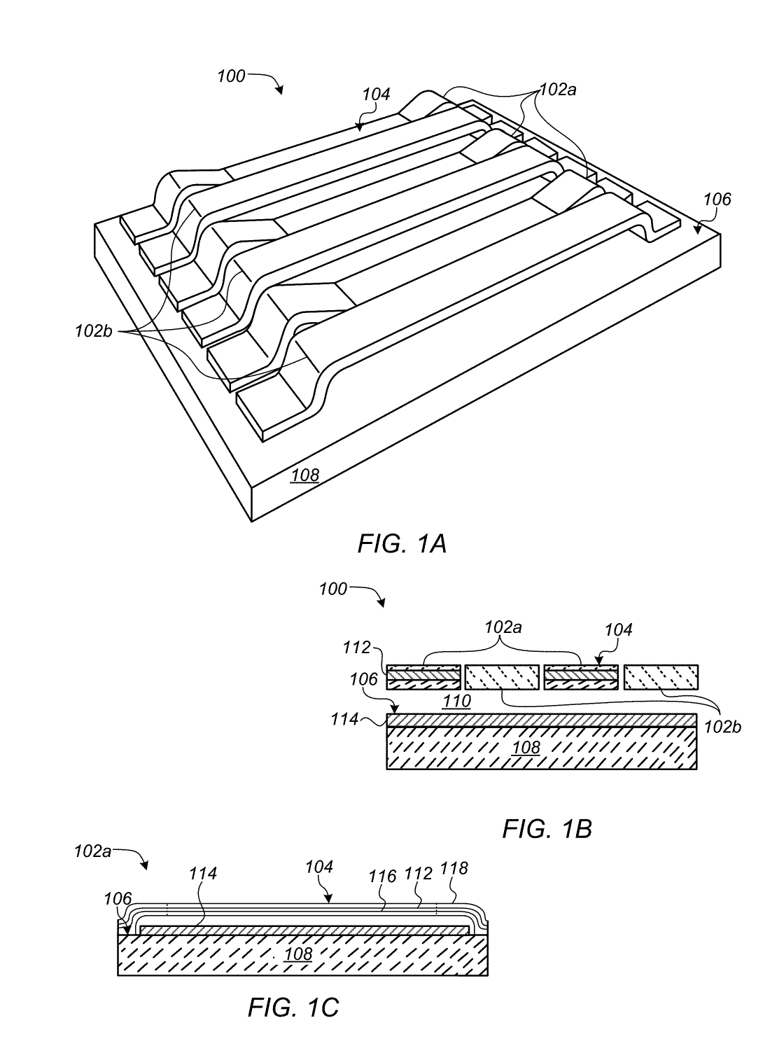

A ribbon-type optical modulator, such as a GLV™, including a number of distributed mirrors or reflectors formed thereon to modulate a beam of light generated by a laser will now be described with reference to FIG. 1. For purposes of clarity, many of the details of MEMS in general and MEMS optical modulators in particular that are widely known and are not relevant to the present invention have been omitted from the following description. The drawings described are only schematic and are non-limiting. In the drawings, the size of some of the elements may be exaggerated and not drawn to scale for illustrative purposes. The dimensions and the relative dimensions may not correspond to actual reductions to practice of the invention.

Referring to FIGS. 1A and 1B, a ribbon-type optical modulator 100 generally includes a number of ribbons 102a, 102b; each having a light reflective surface 104 supported over a surface 106 of a substrate 108. One or more of the ribbons 102a are movable or deflectable through a gap or cavity 110 toward the substrate 108 to form an addressable diffraction grating with adjustable diffraction strength. The ribbons are 102a deflected towards the surface 106 of the substrate 108 by electrostatic forces generated when a voltage is applied between electrodes 112 in the deflectable ribbons 102a and base electrodes 114 formed in or on the substrate. The applied voltages are controlled by drive electronics (not shown in these figures), which may be integrally formed in or on the surface 106 of the substrate 108 below or adjacent to the ribbons 102. Light reflected from the movable ribbons 102a adds as vectors of magnitude and phase with that reflected from stationary ribbons 102b or a reflective portion of the surface 106 beneath the ribbons, thereby modulating light reflected from the optical modulator 100.

A schematic sectional side view of a movable structure or ribbon 102a of the optical modulator 100 of FIG. 1A taken along a longitudinal axis is shown in FIG. 1C. Referring to FIG. 1C, the ribbon 102a includes an elastic mechanical layer 116 to support the ribbon above the surface 106 of the substrate 108, an electrode or conducting layer 112 and a reflective surface 104 overlying the mechanical layer and conducting layer. As shown in FIG. 1C, the reflective surface 104 is formed on a separate distributed mirror or reflector 118 discrete from and overlying the mechanical layer 116 and the conducting layer 112.

Generally, the mechanical layer 116 comprises a taut silicon-nitride (SiN) or silicon-germanium (SiGe) film or layer, and flexibly supported above the surface 106 of the substrate 108 by a number of posts or structures, typically also made of silicon-nitride or silicon-germanium, at both ends of the ribbon 102a. The conducting layer 112 can be formed over and in direct physical contact with the mechanical layer 116, as shown, or underneath the mechanical layer. The conducting layer 112 or ribbon electrode can include any suitable conducting or semiconducting material compatible with standard MEMS fabrication technologies. For example, the conducting layer 112 can include an amorphous or polycrystalline silicon-layer, or a titanium-nitride (TiN) layer. Alternatively, if the reflective layer 118 is above the conductive layer 112, the conductive layer could also be metallic.

The separate, discrete reflecting layer 118, where included, can include any suitable metallic, dielectric or semiconducting material compatible with standard MEMS fabrication technologies, and capable of being patterned using standard lithographic techniques to form the reflective surface 104.

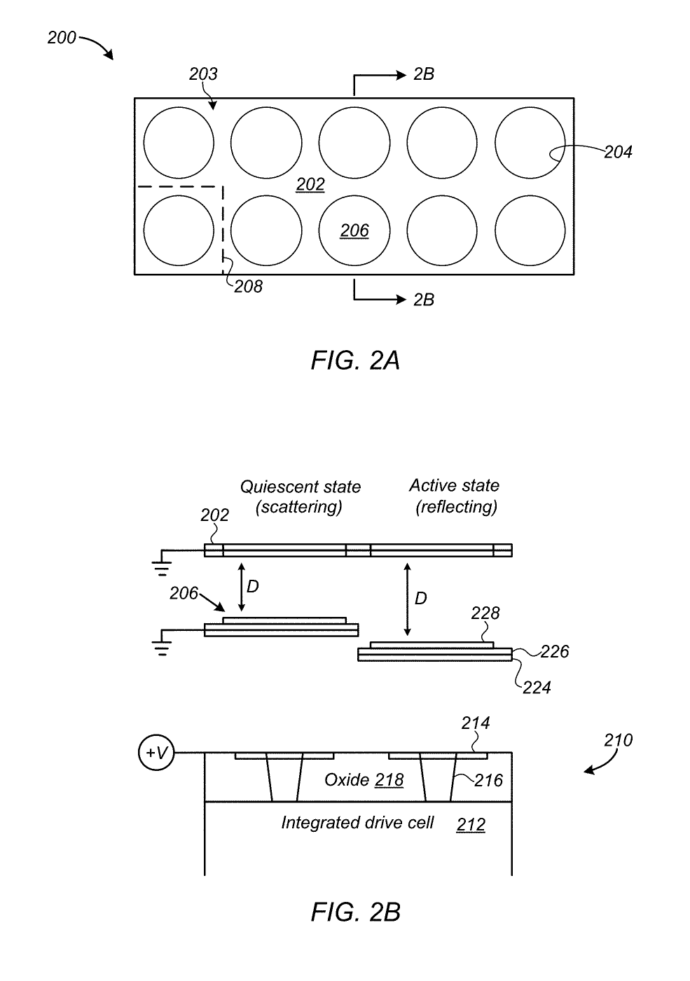

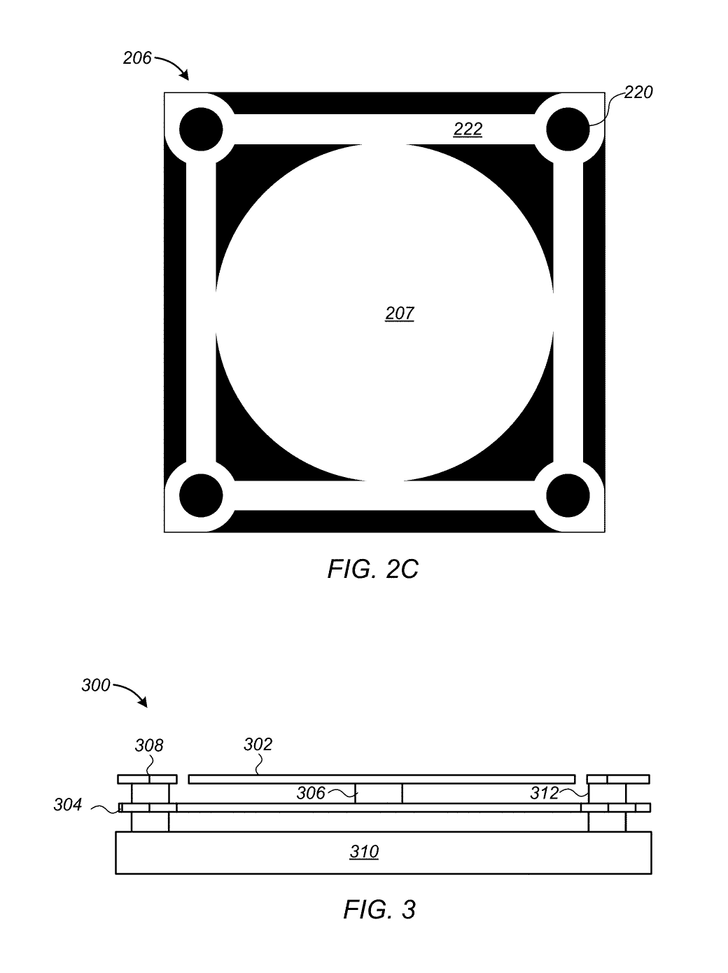

Another type of MEMS-based optical modulator for which the distributed mirror of the present invention is particularly useful is a Planar Light Valve or PLV™ from Silicon Light Machines, Inc., of Sunnyvale, Calif. Referring to FIGS. 2A through 2C, a planar type light valve or PLV™ 200 generally includes two films or membranes having light reflecting surfaces of equal area and reflectivity disposed above an upper surface of a substrate (not shown in this figure). The topmost film is a static tent member or face-plate 202 of a uniform, planar sheet of a material having a first planar light reflective distributed mirror or reflector 203, for example taut silicon-nitride covered on a top surface with one or more layers of material reflective to at least some of the wavelengths of light incident thereon. The face-plate 202 has an array of apertures 204 extending from the top distributed mirror 203 of the member to a lower surface (not shown). The face-plate 202 covers an actuator membrane underneath. The actuator membrane includes a number of flat, displaceable or movable actuators 206. The actuators 206 have second planar distributed mirror or reflector 207 (shown in FIG. 2C) parallel to the first planar distributed mirror 203 of the face-plate 202 and positioned relative to the apertures 204 to receive light passing there through. Each of the actuators 206, the associated apertures 204 and a portion of the face-plate 202 immediately adjacent to and enclosing the aperture form a single, individual modulator 208 or diffractor. The size and position of each of the apertures 204 are chosen to satisfy an “equal reflectivity” constraint. That is the area of the second distributed mirror 207 exposed by a single aperture 204 inside is substantially equal to the reflectivity of the area of the individual modulator 208 outside the aperture 204.

FIG. 2B depicts a cross-section through two adjacent modulators 208 of the light valve 200 of FIG. 2A. In this exemplary embodiment, the upper face-plate 202 remains static, while the lower actuator membrane or actuators 206 move under electrostatic forces from integrated electronics or drive circuitry in the substrate 210. The drive circuitry generally includes an integrated drive cell 212 coupled to substrate or drive electrodes 214 via interconnect 216. An oxide 218 may be used to electrically isolate the electrodes 214. The drive circuitry is configured to generate an electrostatic force between each electrode 214 and its corresponding actuator 206.

Individual actuators 206 or groups of actuators are moved up or down over a very small distance (typically only a fraction of the wavelength of light incident on the light valve 200) relative to first planar distributed mirror 203 of the face-plate 202 by electrostatic forces controlled by drive electrodes 214 in the substrate 210 underlying the actuators 206. Preferably, the actuators 206 can be displaced by n*λ/4 wavelength, where λ is a particular wavelength of light incident on the first and second planar distributed mirrors 203, 207, and n is an integer equal to or greater than 0. Moving the actuators 206 brings reflected light from the second planar distributed mirror 207 into constructive or destructive interference with light reflected by the first planar distributed mirror 203 (i.e., the face-plate 202), thereby modulating light incident on the light valve 200.

For example, in one embodiment of the light valve 200 shown in FIG. 2B, the distance (D) between reflective layers of the face-plate 202 and actuator 206 may be chosen such that, in a non-deflected or quiescent state, the face-plate, or more accurately the first distributed mirror 203, and the actuator (second distributed mirror 207), are displaced from one another by an odd multiple of a quarter wavelength (λ/4), for a particular wavelength λ of light incident on the light valve 200. This causes the light valve 200 in the quiescent state to scatter incident light, as illustrated by the left actuator of FIG. 2B. In an active state for the light valve 200, as illustrated by the right actuator of FIG. 2B, the actuator 206 may be displaced such that the distance between the distributed mirrors 203, 207 of the face-plate 202 and the actuator 206 is an even multiple of λ/4 causing the light valve 200 to reflect incident light.

In an alternative embodiment, not shown, the distance (D) between reflective layers of the face-plate 202 and actuator 206 can be chosen such that, in the actuator's quiescent state, the first and second distributed mirrors 203, 207 are displaced from one another by an even multiple of λ/4, such that the light valve 200 in quiescent state is reflecting, and in an active state, as illustrated by the right actuator, the actuator is displaced by an odd multiple of λ/4 causing it to scatter incident light.

A close up planar view of a single actuator is shown in FIG. 2C. Referring to FIG. 2C, the actuator 206 is anchored or posted to the underlying substrate (not shown in this figure) by a number of posts 220 at the corner of each actuator. The actuators 208 include uniform, planar disks each having a planar distributed mirror 207 and flexibly coupled by hinges or flexures 222 of an elastic material to one or more of the posts 220. The actuator 206 includes an elastic mechanical layer, such as silicon-nitride or silicon-germanium, that flexibly couples discs of the actuator to the posts 220, an electrically conductive material, such as a titanium-nitride layer, and a reflective layer overlying the conducting layer. The distributed mirrors 207 of the actuators 206 can also include one or more layers of material reflective to at least some of the wavelengths of light incident thereon.

A schematic block diagram of a sectional side view of the actuator 206 of FIG. 2C is shown in FIG. 2B. Referring to FIG. 2B, the actuator 206 includes the elastic mechanical layer 224 that flexibly couples discs of the actuator to the posts 220, an electrically conductive layer 226, such as a titanium-nitride layer, and a reflective layer 228 overlying the conducting layer. The dielectric mirrors 207 of the actuators 206 can also include one or more layers of material reflective to at least some of the wavelengths of light incident thereon.

Although the light reflective surface of the actuator 206 is shown and described above as being positioned below the light reflective surface 203 of the face-plate 202 and between the first reflective surface and the upper surface of the substrate, it will be appreciated that the distributed mirror 207 of the actuator can alternatively be raised above the movable actuator so as to be positioned coplanar with or above the light reflective surface of the face-plate 202.

In an alternative embodiment of a PLV™, an individual modulator 300 of which is shown in FIG. 3, distributed mirrors or reflectors 302 are mechanically isolated or separated from the taut silicon-nitride of the actuators 304 by a center support 306, and the face-plate 308 is suspended over an integrated drive cell 310 by one or more posts 312 at the corners of the individual modulator 300. Moving the actuators 304 brings light reflected from the reflectors 302 into constructive or destructive interference with light reflected by the static or stationary face-plate 308.

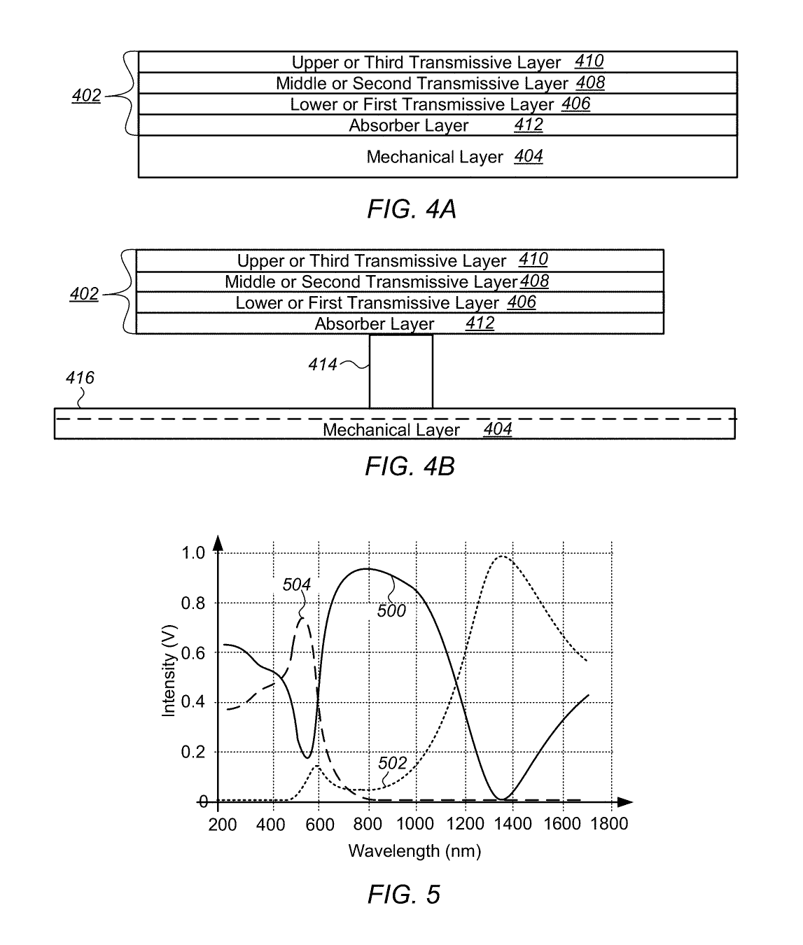

In one embodiment, shown in FIG. 4A, the reflectors are distributed mirrors including a stack of flexible transmissive layers with different optical characteristics or properties, such as reflection, transmission and absorption. Referring to FIG. 4A, the distributed mirror 402 includes a first or lower transmissive layer 406 overlying the mechanical layer 404 of the MEMS-based optical modulator, a middle transmissive layer 408 on the first or lower transmissive layer, and a third or top transmissive layer 410 on the second or middle transmissive layer. The thicknesses of these layers are adjusted so as to comprise one quarter wave of the wave of the target wavelength. Suitable materials for the transmissive layers can include poly-crystalline silicon, silicon-oxide, silicon-carbide, aluminum-arsenide, zirconium-oxide and titanium-oxide. Optionally, in certain embodiments, such as that shown in FIG. 4A, the mirror 402 further includes an absorbing layer 412 to absorb and re-emit, or reflect incident light. Suitable materials for the absorbing layer 412 can include metallic films as well as native or doped semiconductors. The enhanced reflectivity of stack of two or more transmissive layers over an absorbing layer reduces or substantially eliminates degradation of the MEMS-based modulator as a consequence of high laser fluence.

In an alternative embodiment, shown in FIG. 4B, the reflectors are distributed mirrors including a stack of substantially inflexible layers mechanically isolated or separated from a flexible mechanical layer by a center support 414. Referring to FIG. 4B, as described above with respect to FIG. 4A the distributed mirror 402 can include a first or lower transmissive layer 406 overlying of the flexible mechanical layer, a middle transmissive layer 408 on the first or lower transmissive layer, and a third or top transmissive layer 410 on the second or middle transmissive layer. Generally, the mechanical layer 404 further includes an actuator electrode or electrode layer 416 formed thereon. However, when silicon-germanium is used as a material of the mechanical layer 404, forming an actuator electrode is not necessary as the silicon-germanium mechanical layer is itself conductive.

A graph illustrating the reflection 500, transmission 502 and absorption 504 of a distributed or Bragg mirror including alternating transmissive layers of poly-crystalline silicon, silicon-dioxide and poly-crystalline silicon at near-infrared (NIR) wavelengths of from about 700 to 1000 nanometers (nm) is shown in FIG. 5. Referring to FIG. 5 it is seen that a distributed mirror including a first transmissive layer of 56 nm poly-crystalline silicon, a second transmissive layer of 68 nm silicon-dioxide and a top reflective layer of 56 nm poly-crystalline silicon, a second reflective layer of 68 nm silicon-dioxide exhibits a total reflection of about 95% at or near a center wavelength of 800 nm.

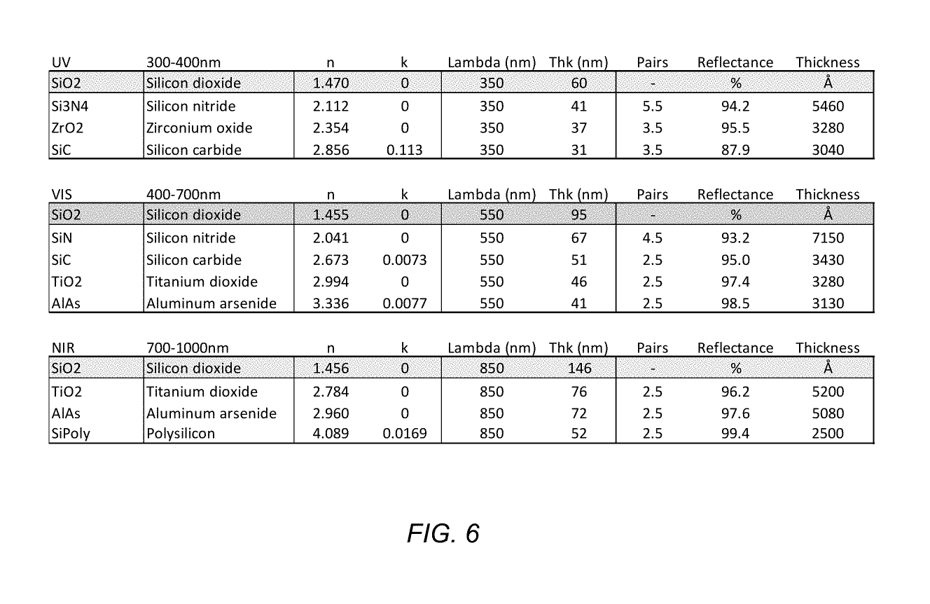

FIG. 6 is a table giving the lowest absorption (k), and greatest index difference (n) and percent reflectance of different materials for use in a distributed mirror in the ultraviolet (UV), visible (VIS) and near infrared (NIR) wavelengths.

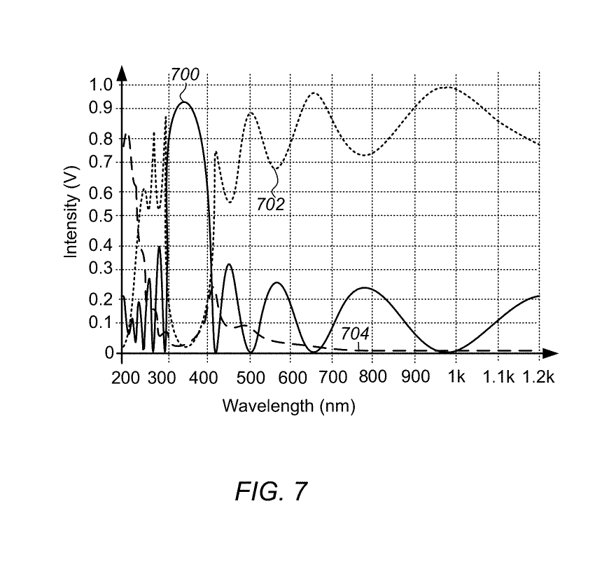

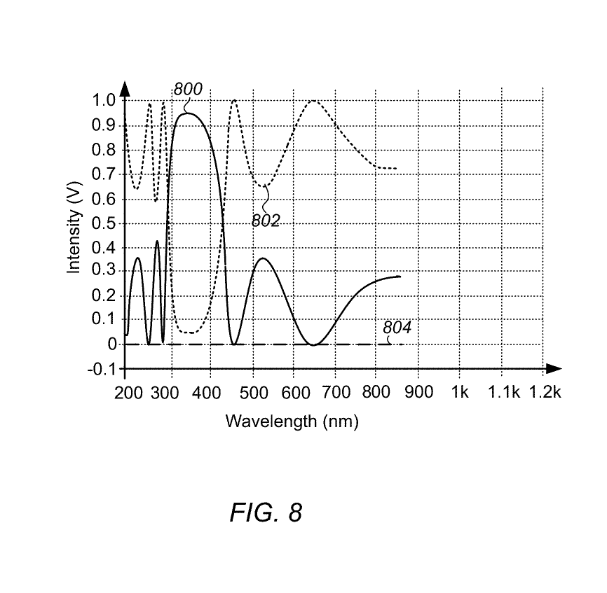

FIG. 7 is a graph illustrating the reflection 700, transmission 702 and absorption 704 of light in the ultraviolet (UV) wavelengths by a distributed mirror including eleven alternating layers of silicon-nitride and silicon-dioxide (SiO₂). More specifically, the Bragg distributed mirror includes six layers of silicon-nitride each having a thickness of about 41 nm interleaved with five layers of silicon-dioxide each having a thickness of about 60 nm, for a total thickness of 546 nm. Referring to FIG. 7 it is seen that this particular embodiment has a total reflection of 94.2% at a wavelength of 350 nm.

FIG. 8 is a graph illustrating the reflection 800, transmission 802 and absorption 804 of light in the ultraviolet (UV) wavelengths by a distributed mirror including seven alternating layers of a zirconium-oxide (ZrO₂) and silicon-dioxide. More specifically, the Bragg distributed mirror includes four layers of zirconium-oxide each having a thickness of about 37 nm interleaved with three layers of silicon-dioxide each having a thickness of about 60 nm, for a total thickness of 328 nm. Referring to FIG. 8 it is seen that this particular embodiment has a total reflection of 95.5% at a wavelength of 350 nm.

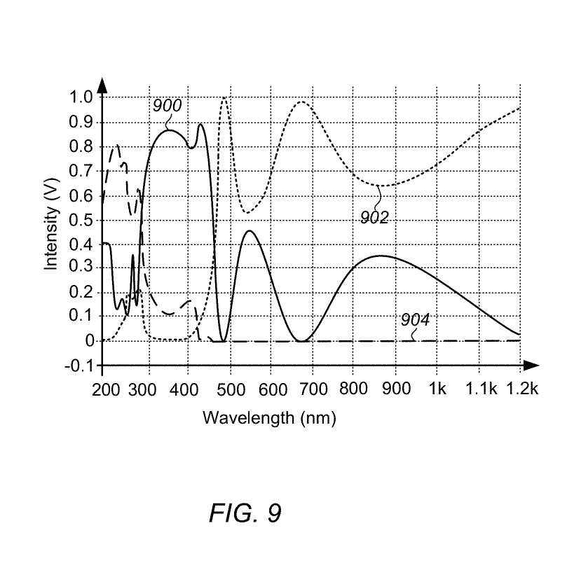

FIG. 9 is a graph illustrating the reflection 900, transmission 902 and absorption 904 of light in the ultraviolet (UV) wavelengths by a distributed mirror including seven alternating layers of a silicon-carbide and silicon-dioxide. More specifically, the Bragg distributed mirror includes four layers of silicon-carbide each having a thickness of about 31 nm interleaved with three layers of silicon-dioxide each having a thickness of about 60 nm, for a total thickness of 304 nm. Referring to FIG. 9 it is seen that this particular embodiment has a total reflection of 88% at a wavelength of 350 nm

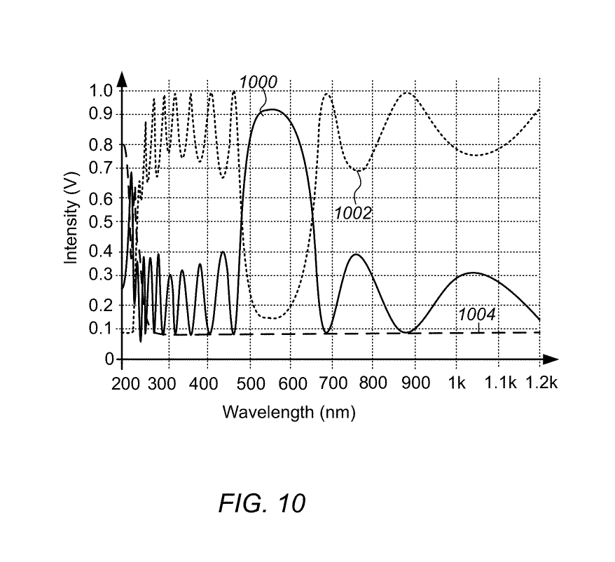

FIG. 10 is a graph illustrating the reflection 1000, transmission 1002 and absorption 1004 of light in the visible (VIS) wavelengths by a distributed mirror including nine alternating layers of silicon-nitride and silicon-dioxide. More specifically, the Bragg distributed mirror includes five layers of silicon-nitride each having a thickness of about 67 nm interleaved with four layers of silicon-dioxide each having a thickness of about 95 nm, for a total thickness of 715 nm. Referring to FIG. 10 it is seen that this particular embodiment has a total reflection of 93.2% at a wavelength of 550 nm.

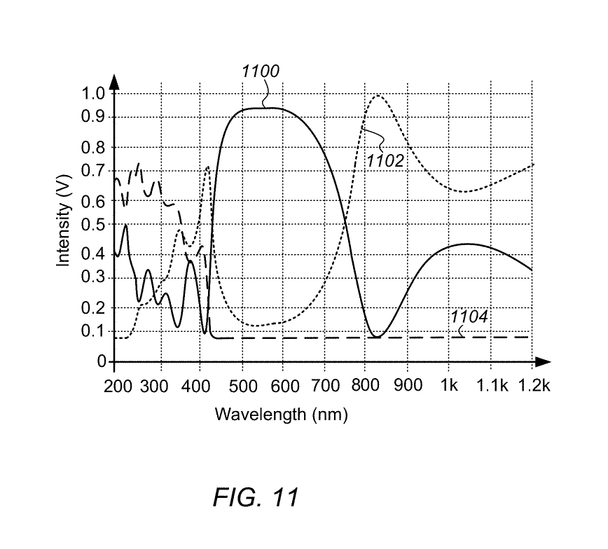

FIG. 11 is a graph illustrating the reflection 1100, transmission 1102 and absorption 1104 of light in the visible (VIS) wavelengths by a distributed mirror including five alternating layers of silicon-carbide and silicon-dioxide. More specifically, the Bragg distributed mirror includes three layers of silicon-carbide each having a thickness of about 51 nm interleaved with two layers of silicon-dioxide each having a thickness of about 95 nm, for a total thickness of 343 nm. Referring to FIG. 11 it is seen that this particular embodiment has a total reflection of 95% at a wavelength of 550 nm.

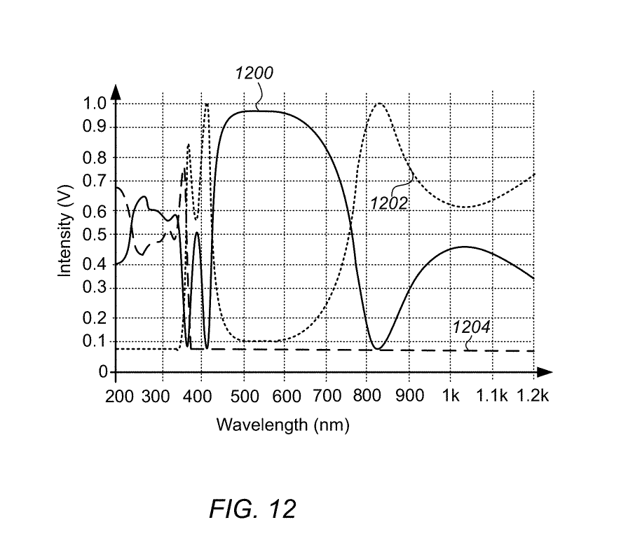

FIG. 12 is a graph illustrating the reflection 1200, transmission 1202 and absorption 1204 of light in the visible (VIS) wavelengths by a distributed mirror including five alternating layers of titanium-oxide and silicon-dioxide. More specifically, the Bragg distributed mirror includes three layers of titanium-oxide each having a thickness of about 46 nm interleaved with two layers of silicon-dioxide each having a thickness of about 95 nm, for a total thickness of 328 nm. Referring to FIG. 12 it is seen that this particular embodiment has a total reflection of 97.4% at a wavelength of 550 nm.

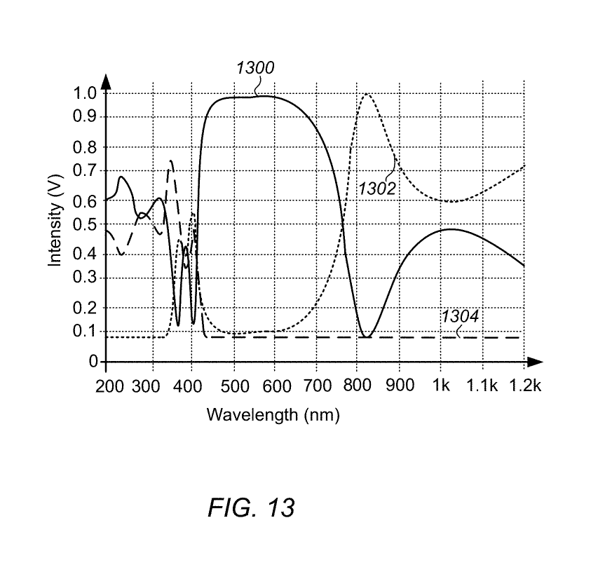

FIG. 13 is a graph illustrating the reflection 1300, transmission 1302 and absorption 1304 of light in the visible (VIS) wavelengths by a distributed mirror including five alternating layers of aluminum-arsenide (AlAs) and silicon-dioxide. More specifically, the Bragg distributed mirror includes three layers of aluminum-arsenide (AlAs) each having a thickness of about 41 nm interleaved with two layers of silicon-dioxide each having a thickness of about 95 nm, for a total thickness of 313 nm. Referring to FIG. 13 it is seen that this particular embodiment has a total reflection of 98.5% at a wavelength of 550 nm.

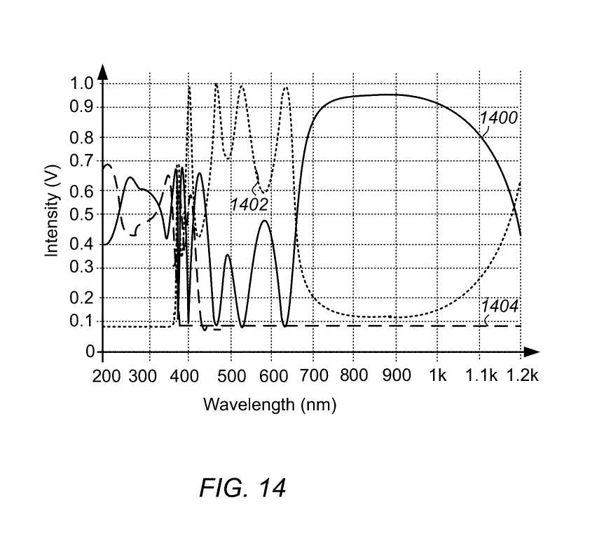

FIG. 14 is a graph illustrating the reflection 1400, transmission 1402 and absorption 1404 of light in the near infrared (NIR) wavelengths by a distributed mirror including five alternating layers of titanium-oxide (TiO₂) and silicon-dioxide. More specifically, the Bragg distributed mirror includes three layers of titanium-oxide each having a thickness of about 76 nm interleaved with two layers of silicon-dioxide each having a thickness of about 146 nm, for a total thickness of 520 nm. Referring to FIG. 14 it is seen that this particular embodiment has a total reflection of 96.2% at a wavelength of 850 nm.

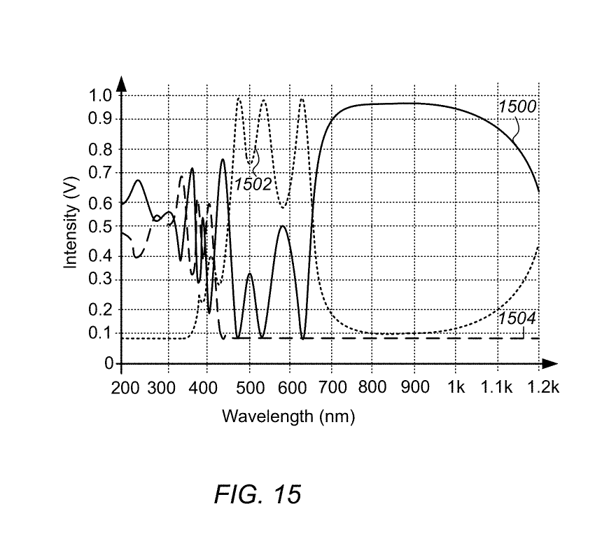

FIG. 15 is a graph illustrating the reflection 1500, transmission 1502 and absorption 1504 of light in the near infrared (NIR) wavelengths by a distributed mirror including five alternating layers of aluminum-arsenide (AlAs) and silicon-dioxide. More specifically, the Bragg distributed mirror includes three layers of aluminum-arsenide (AlAs) each having a thickness of about 72 nm interleaved with two layers of silicon-dioxide each having a thickness of about 146 nm, for a total thickness of 508 nm. Referring to FIG. 15 it is seen that this particular embodiment has a total reflection of 97.6% at a wavelength of 850 nm.

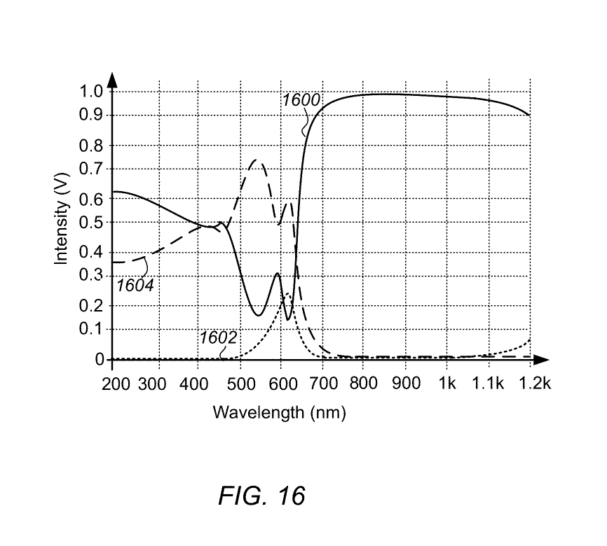

FIG. 16 is a graph illustrating reflection 1600, transmission 1602 and absorption 1604 of light in the near infrared (NIR) wavelengths by a distributed mirror including five alternating layers of poly-crystalline silicon (SIPOLY) and silicon-dioxide. More specifically, the Bragg distributed mirror includes three layers of poly-crystalline silicon each having a thickness of about 52 nm interleaved with two layers of silicon-dioxide each having a thickness of about 146 nm, for a total thickness of 448 nm. Referring to FIG. 16 it is seen that this particular embodiment has a total reflection of 99.4% at a wavelength of 850 nm.

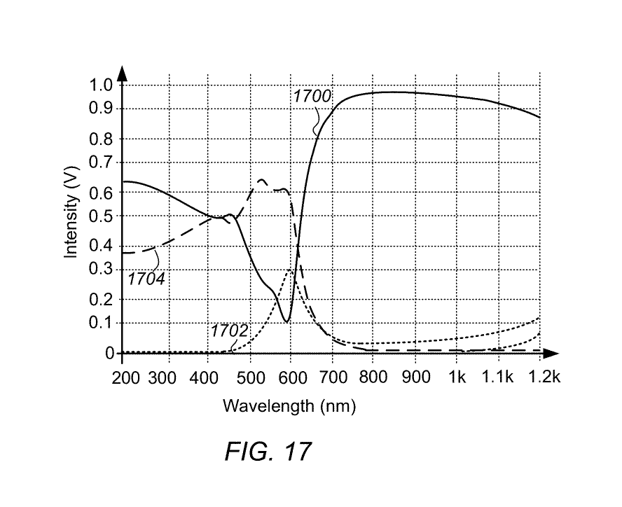

FIG. 17 is a graph illustrating the reflection 1700, transmission 1702 and absorption 1704 of light in the near infrared (NIR) wavelengths by a distributed mirror including three alternating layers of poly-crystalline silicon and silicon-dioxide. More specifically, the Bragg distributed mirror includes two layers of poly-crystalline silicon each having a thickness of about 52 nm interleaved with a single layer of silicon-dioxide having a thickness of about 146 nm, for a total thickness of 250 nm. Referring to FIG. 17 it is seen that this particular embodiment has a total reflection of 96.7% at a wavelength of 850 nm.

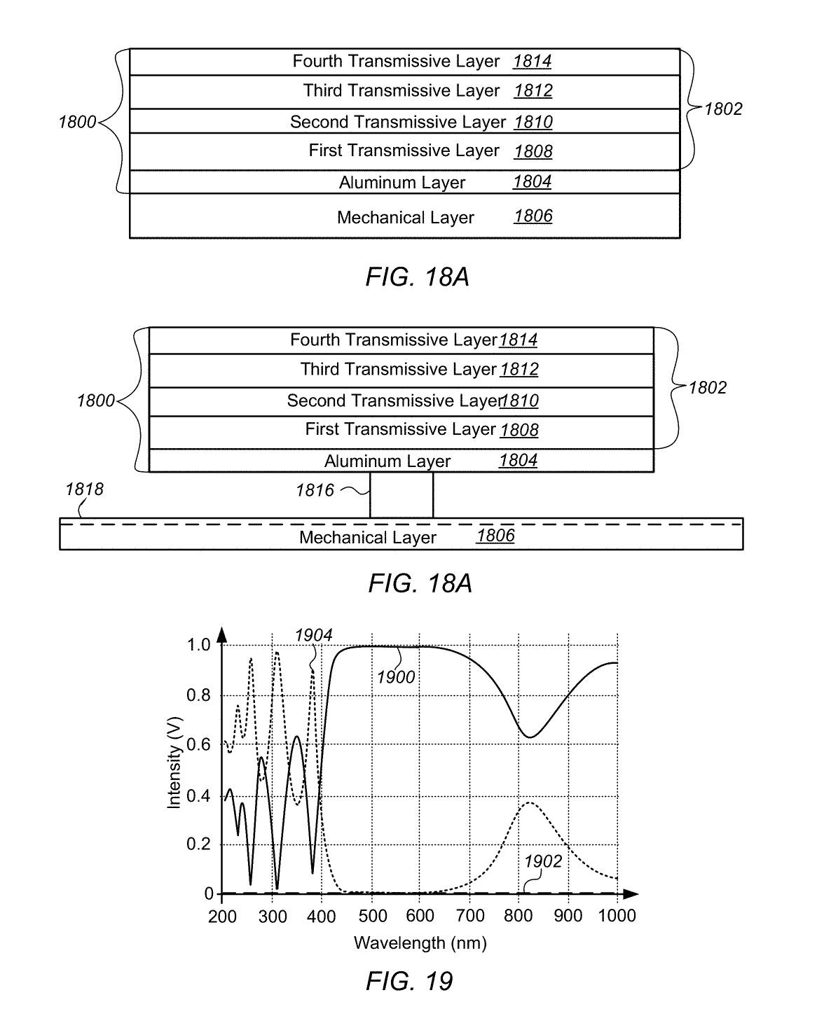

In other embodiments, the distributed mirror can include a stack of transmissive layers overlying an absorbing layer on the mechanical layer of a MEMS-based optical modulator to absorb and re-emit, or reflect light incident thereon. The absorbing containing layer can include any suitable metal aluminum (Al), silver (Ag), gold (Au), chrome (Cr), copper (Cu), nickel (Ni), platinum (Pt), palladium (Pd), titanium (Ti), tungsten (W) or mixtures or alloys thereof. Referring to FIG. 18A, in one embodiment the Bragg mirror 1800 includes a stack of transmissive layers 1802 overlying an aluminum absorbing layer 1804 on the mechanical layer 1806 of a MEMS-based optical modulator (not shown in this figure), such as those shown and described above with respect to FIGS. 1A-3. stack of transmissive layers 1802 includes a lower or first transmissive layer 1808 overlying the aluminum absorber layer 1804, a second transmissive layer 1810 overlying the first transmissive layer, a third transmissive layer 1812 on the second transmissive layer, and an upper or fourth transmissive layer 1814 on the third transmissive layer.

In an alternative embodiment, shown in FIG. 18B, the reflectors are distributed mirrors including a stack of substantially inflexible layers mechanically isolated or separated from a flexible mechanical layer by a center support 1816. Referring to FIG. 18B, as described above with respect to FIG. 18A the distributed mirror 1800 can include a first or lower transmissive layer 1808 overlying the aluminum absorber layer 1804, a middle transmissive layer 1810 on the first or lower transmissive layer, and a third transmissive layer 1812 on the second or middle transmissive layer and an upper or fourth transmissive layer 1814 on the third transmissive layer. Generally, the mechanical layer 1806 further includes an actuator electrode or electrode layer 1818 formed thereon. However, when silicon-germanium is used as a material of the mechanical layer 1806, forming an actuator electrode is not necessary as the silicon-germanium mechanical layer is itself conductive.

Suitable materials for the stack of transmissive layers 1802 can include dielectrics or doped semiconductors including poly-crystalline silicon, silicon-dioxide, titanium-oxide, silicon-carbide, aluminum-arsenide, zirconium-oxide and titanium-oxide. Suitable materials for the absorbing layer 1804 can include substantially pure aluminum or thermally compatible aluminum containing alloys.

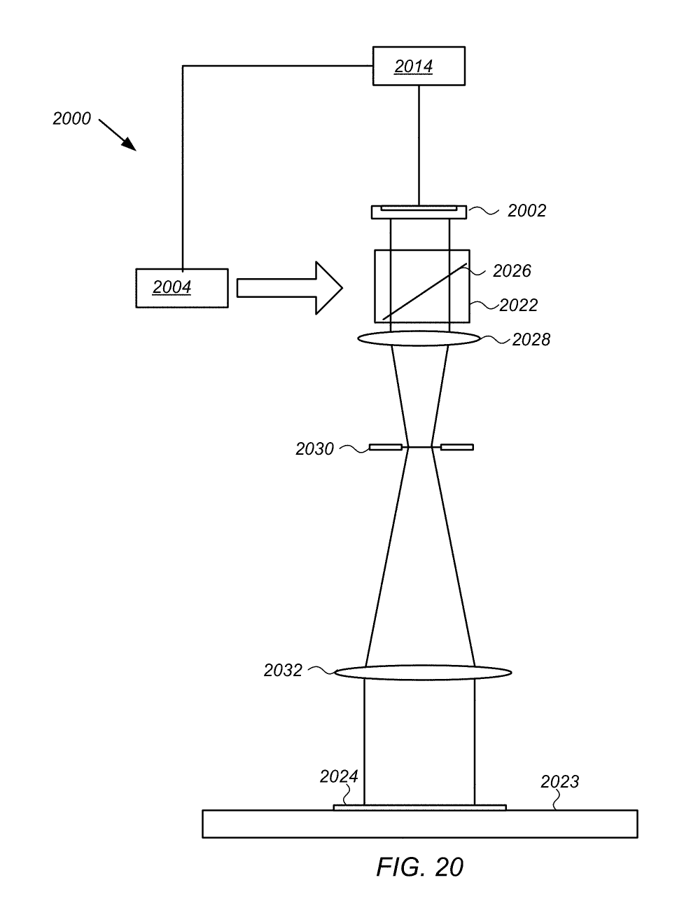

A graph illustrating the reflection 1900, transmission 1902 and absorption 1904 of a Bragg mirror including a stack of transmissive layers overlying an aluminum absorbing layer, and including alternating first and third reflective layers of silicon-carbide and second and fourth reflective silicon-dioxide at wavelengths of from about 350 to about 1500 nm is shown in FIG. 19. Referring to FIG. 19 it is seen that Bragg mirror 1800 including a first transmissive layer 1808 of 85.62 nm silicon-dioxide, a second transmissive layer 1810 of 46.82 nm silicon-carbide, a third transmissive layer 1812 of 85.62 nm silicon-dioxide, and a fourth transmissive layer 1814 of 46.82 nm silicon-carbide, all overlying an aluminum layer 1804 of 50 nm, exhibits a total reflection of greater than about 90%, and more specifically of about 99.3% at or near a center wavelength of 532 nm. It is further noted that the Bragg mirror 1800 exhibits a transmission 1902 and absorption 1904 of about 0% at or near the center wavelength of 532 nm.

Optionally, the aluminum absorbing layer 1804 can further serves to prevent residual light from being transmitted to underlying regions, and/or as the electrode in a deflectable ribbon or actuator layer, as shown and described in connection with FIGS. 1A-3 above.

In addition, it will be understood that the aluminum layer 1804 can be included within Bragg mirror 402 shown and described above in FIGS. 4A and 4B, or described in connection with any of the embodiments of FIGS. 5, and 7 through 17 by inserting aluminum as absorbing layer 412.

In another aspect, the present disclosure is directed to a material processing system or laser processing system including a number of MEMS-based optical modulators, each including a number of distributed mirrors or reflectors, grouped or ganged together in a one dimensional (1D) or two-dimensional (2D) array to create a high power spatial light modulator (SLM). Material or laser processing systems, also known as laser-based material processing systems are particularly useful in additive manufacturing processes, such as selective laser sintering (SLS), selective laser melting, sintering, oxidation, reaction, ablation or other laser-induced material modification. By selective laser melting it is meant an additive manufacturing process that uses high energy, typically in the form of a laser beam, to create three-dimensional parts by fusing fine a powder of a material, such as metal, together on a surface of substrate or workpiece. By selective laser sintering it is meant an additive manufacturing process that uses a laser as the power source to sinter powdered material (typically metal), binding the material together to create a solid structure. It is similar to selective laser melting, but differs in that the material is not fully melted allowing different properties, such as crystal structure, porosity, etcetera.

An embodiment of a laser processing system suitable for use in additive manufacturing processes will now be described with reference to FIG. 20. Generally, the laser processing system includes a MEMS-based SLM including a number of distributed mirrors or reflectors formed thereon to modulate a beam of light generated by a laser. Referring to FIG. 20, the laser processing system 2000 includes a MEMS-based SLM 2002, a high powered, nano-, pico- or femto-second laser 2004, imaging optics and illumination optics, a controller 2014 to provide voltages to drive the MEMS-based SLM and control operation of the laser 2004 and a workpiece support 2023 to hold a target workpiece 2024.

Generally, the illumination optics include a number of elements including lenses, mirrors and prisms, designed to transfer a light beam from the laser 2004, such as an Ultra Violet laser, to the MEMS-based SLM 2002 to illuminate an area substantially equal to that of the reflective surface of the MEMS-based SLM. In the embodiment shown, the illumination optics include a polarizing beam splitter (PBS) 2022, which reflects light having a first polarization onto the MEMS-based SLM 2002, and transmits the light having a second polarization from the MEMS-based SLM towards a target wafer or workpiece 2024 through the imaging optics. For example, the PBS 2022 can be adapted to reflect light having a Transverse-Electric (TE) polarization towards the MEMS-based SLM 2002, and to transmit light having a Transverse-Magnetic (TM) polarization toward the target workpiece 2024. The light that is initially directed toward the MEMS-based SLM 2002 by the PBS 2022 in the TE state will pass twice through a quarter-wave plate (QWP) 2026, thus converting it to TM polarization and allowing to pass through the PBS and on to the imaging optics that follow.

As shown, the imaging optics can include magnification and filtering elements, such as a first Fourier Transform (FT) lens 2028 to focus and direct light from the PBS 2022 onto a FT filter 2030 to select the 0th order modulated light, and a second, larger Inverse FT lens 2032 to enlarge the image generated by the SLM 2002 and project it onto the target substrate 2024

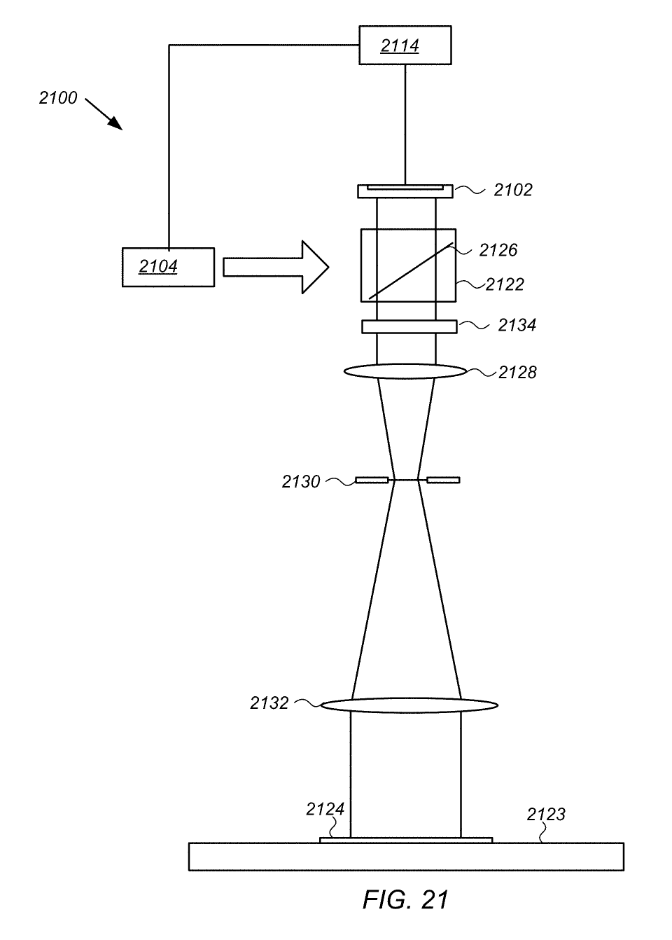

Another embodiment of a laser processing system using phase modulation and including a MEMS-based SLM including a number of distributed mirrors or reflectors formed thereon to modulate a beam of light generated by a laser will now be described with reference to FIG. 21. FIG. 21 is a schematic block diagram of a laser processing system 2100 similar to that of FIG. 20 and further includes an element or elements, such as a crystal 2134, to vary an intensity of phase modulated light or convert phase modulated light to an intensity modulation.

In accordance with another embodiment of the invention of the present disclosure, and similar to the laser processing system 2000 of FIG. 20, the laser processing system 2100 further includes in addition to a high-power handling MEMS-based SLM 2102, a high powered, Nano-, pico- or femto-second laser 2104, imaging optics and illumination optics, a controller 2114 to provide voltages to drive the MEMS-based SLM and control operation of the laser 2104 and a workpiece support 2123 to hold a target workpiece 2124.

Generally, the illumination optics include a number of elements including lenses, mirrors and prisms, designed to transfer a light beam from the laser 2104, such as an Ultra Violet laser, to the MEMS-based SLM 2102 to illuminate an area substantially equal to that of the reflective surface of the MEMS-based SLM. In the embodiment shown, the illumination optics include a PBS 2122, which reflects light having a first polarization onto the MEMS-based SLM 2102, and transmits the light having a second polarization from the MEMS-based SLM towards a target wafer or workpiece 2124 through the imaging optics. For example, the PBS 2122 can be adapted to reflect light having a TE polarization towards the MEMS-based SLM 2102, and to transmit light having a TM polarization toward the target workpiece 2124. The light that is initially directed toward the MEMS-based SLM 2102 by the PBS 2122 in the TE state will pass twice through QWP 2126, thus converting it to TM polarization and allowing to pass through the PBS and on to the imaging optics that follow.

As shown, the imaging optics can include magnification and filtering elements, such as a FT lens 2128 to focus and direct light from the MEMS-based SLM 2102 onto a FT filter, a FT filter 2130 to select the 0th order modulated light, and a second, larger Inverse FT lens 2132 to enlarge the image generated by MEMS-based SLM and project it onto the target workpiece 2124.

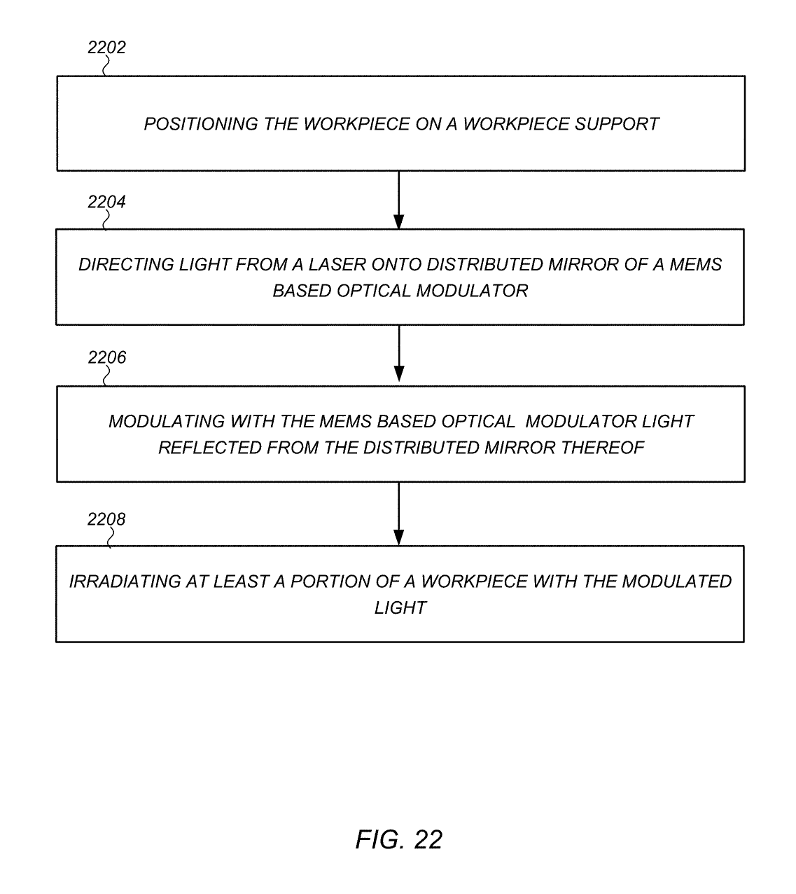

A method for processing a workpiece using the laser processing system of FIG. 20 or 21 will now be described with reference to the flow chart of FIG. 22. Referring to FIG. 22, the method begins with positioning the workpiece on a workpiece support. (step 2202) Next, light or a light beam from a laser is directed onto distributed mirrors or reflectors of a MEMS-based SLM. (step 2204) The SLM can be either a diffractive SLM or a phase modulating SLM. The light reflected from the distributed mirror of the MEMS-based diffractive SLM reflective is modulated thereby (step 2206), and at least a portion of a workpiece with the modulated light irradiated with the modulated light. (step 2208) As noted above the processing can include sintering or ablating the workpiece for a number of different applications including cutting, marking, engraving, two dimensional (2D) and three dimensional (3D) printing, testing and measuring, or additive manufacturing process such as selective laser melting, sintering, oxidation or ablation of a material on the portion of the workpiece.

In yet another aspect, the present disclosure is directed to a MEMS-based optical spatial light modulator having a non-metallic, multilayer optical reflector, capable of handling high-power lasers such as those used in the applications described above.

Metallic coatings, such as aluminum, are commonly used as reflectors in conventional mems spatial light modulators because these coatings exhibit good reflectivity across a wide spectral band, and because tools for forming such metallic coatings are widely available in semiconductor and MEMS foundries. However, metal coatings typically have low melt temperatures and relatively high chemical activity limiting the lifetime of modulators with metallic reflectors in applications using high fluence or high power lasers. Aluminum in particular has a relatively low melt temperature of about 660° C. Additionally, it has been observed metals migrate under high thermal gradients due to the Soret effect, and can oxidize or undergo other chemical reactions under UV illumination, reducing the reflectivity of the reflectors. The above problems and eliminated by the use of non-metallic, multilayer optical reflectors.

The high power handling optical modulators with distributed mirrors according to an embodiment of the present disclosure are also particularly useful in additive three dimensional (3D) printing systems. 3D printing systems can use either a photopolymerization technology or Selective laser sintering (SLS). In photopolymerization is a liquid photopolymer or resin is exposed to a modulated beam of light that converts the liquid into a solid, building an object to be printed from a series of two-dimensional layers. Selective laser sintering involves melting and fusing together of fine, typically metal, particles using a high power laser to build successive cross-sections of an object.

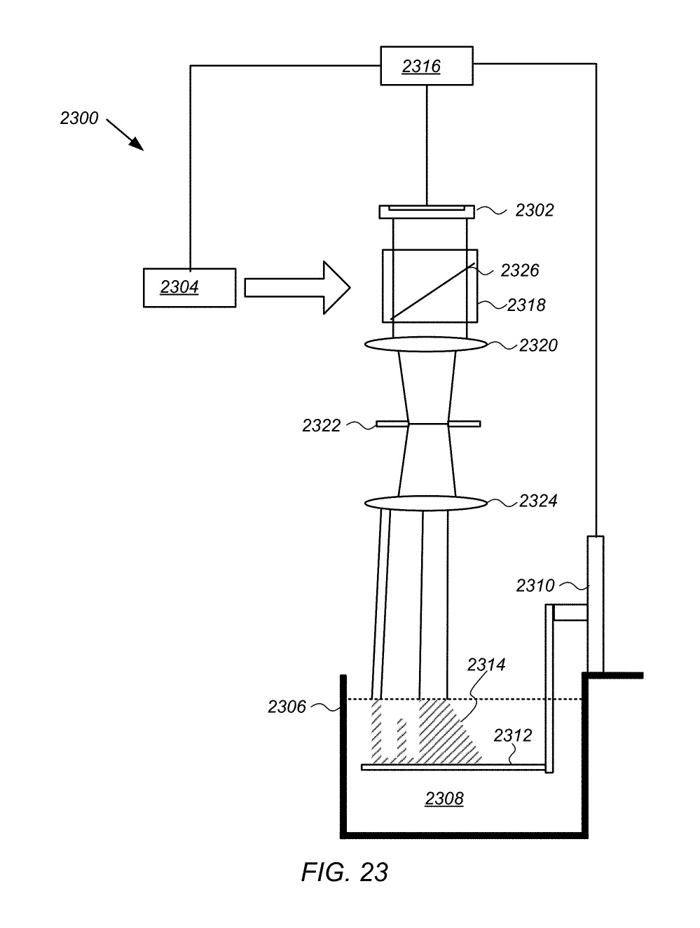

An embodiment of a polymerization 3D printing system will now be described with reference to FIG. 23. Generally, the 3D printing system 2300 includes a MEMS-based SLM 2302 including a number of distributed mirrors or reflectors formed thereon to modulate a beam of light generated by a laser 2304, a vat 2306 containing the photopolymer or resin 2308, and a transport mechanism 2310 to raise and lower a work surface 2312 on which an object 2314 is printed into the vat. Referring to FIG. 23, the 3D printing system 2300 further includes illumination optics to transfer light from the laser 2304 to the SLM 2302, imaging optics to transfer modulated light from the SLM toward the work surface 2312, a controller 2316 control operation of the laser, SLM and transport mechanism 2310 to hold the target workpiece or object 2314. In the embodiment shown, the illumination optics include a polarizing beam splitter (PBS) 2318 including a quarter-wave plate (QWP) 2326, which reflects light having a first polarization onto the SLM 2302, and transmits the light having a second polarization from the SLM towards work surface 2312 through the imaging optics.

As shown, the imaging optics can include magnification and filtering elements, such as a first Fourier Transform (FT) lens 2320 to focus and direct light from the PBS 2318 onto a FT filter 2322 to select the 0th order modulated light, and a second, larger Inverse FT lens 2324 to enlarge the image generated by the SLM 2302 and project it onto a surface of the resin 2308 immediately above or adjacent to the work surface 2312.

The transport mechanism 2310 is adapted and controlled by the controller 2316 to lower the work surface 2312 into the vat 2306 as the modulated light converts the resin 2308 into a solid, building successive layers or cross-sections of the object 2314 to be printed. Generally, the layers can be from about 100 μm to 1 mm thick. Optionally, the transport mechanism 2310 can be further adapted to move or reposition the work surface 2312 laterally to enable simultaneous printing of multiple objects or objects larger than the area imaged onto the work surface.

In one embodiment, the MEMs-based optical spatial light modulator is a ribbon-type is a ribbon-type spatial light modulator, such as that shown above and described with reference to FIGS. 1A through 1C, in which the distributed mirrors 118, on the ribbons 102a, 102b are replaced with non-metallic, multilayer optical reflectors including multiple pairs or alternating layers of high and low index materials.

In another embodiment, the MEMs-based optical spatial light modulator is a Planar Light Valve or PLV™, such as that shown above and described with reference to FIGS. 2A through 2C, in which the first and second distributed mirrors 203, 207, on the face-plate 202 and actuator 206 are replaced with non-metallic, multilayer optical reflectors including multiple pairs or alternating layers of high and low index materials.

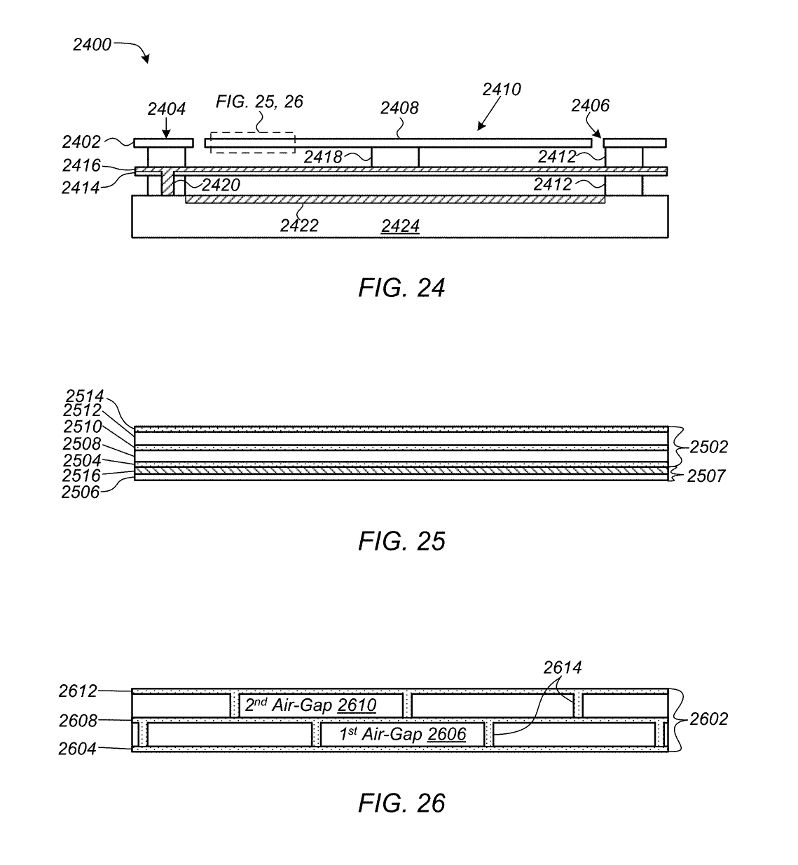

In an alternative embodiment of the PLV™, shown in FIG. 24, the non-metallic, multilayer optical reflectors of the actuators are physically separated from the mechanical and electrode layers of the actuators to enable the reflectors on the face-plate and actuator to be co-planar in the reflecting state. FIG. 24 is a schematic side view of a single diffractor or modulator 2400 of a PLV™-type optical spatial light modulator including non-metallic, multilayer optical reflectors according an embodiment of the present disclosure. Referring to FIG. 24, each individual modulator 2400 includes a portion of a static tent member or face-plate 2402 having a first non-metallic, multilayer optical reflector 2404 formed thereon, and an aperture 2406 through which a second non-metallic, multilayer optical reflector 2408 of a movable actuator 2410 is exposed. The size and position of the aperture 2406 is chosen to satisfy an “equal reflectivity” constraint. That is the area of the second optical reflector 2408 exposed by the aperture is substantially equal to the reflectivity of the area of the face-plate 2402 of the individual modulator 2400 outside the aperture 2406. Moving the actuator 2410 brings light reflected from the second optical reflector 2408 into constructive or destructive interference with light reflected by the first optical reflector 2404 of the static or stationary face-plate 2402.

The face-plate 2402 is supported by one or more posts 2412 at corners of the modulator 2400, and can be formed solely by layers of the first optical reflector 2404. Alternatively the face-plate 2402 can further include a uniform, planar sheet of a dielectric or semiconducting material, for example a taut silicon-nitride or silicon-germanium layer, over which the first optical reflector 2404 is formed.

The movable actuator 2410 further includes in addition to the second optical reflector 2408 a mechanical layer 2414 and an actuator electrode or electrode layer 2416 separated from the second optical reflector 2408 by a central support 2418. The mechanical layer 2414 can include a taut layer of a material, such as silicon-nitride or silicon-germanium, supported by posts 2412 at corners of the modulator 2400. The electrode layer 2416 can include a metal or other conductive material, such as a doped poly-crystalline silicon, formed on the mechanical layer 2414, and is electrically coupled to ground or to drive electronics (not shown in this figure) through electrically conductive vias 2420 formed in or over one or more of the posts 2412. In operation, the movable actuator 2410 is deflected towards a lower electrode 2422 formed in or on the substrate 2424 by electrostatic forces generated when a voltage is applied between the base electrode and the electrode layer 2416 in the movable actuator.

It is noted that although the electrode layer 2416 is shown as being formed on top of the mechanical layer 2414, this need not be the case in every embodiment, and that the mechanical layer can alternatively be formed on top of the electrode layer. This later embodiment is particularly advantageous where the second optical reflector 2408 is separated from the mechanical layer 2414 and the electrode layer 2416 by the central support 2418, and the mechanical layer and the central support are formed from the same material.

In some embodiments, the non-metallic, multilayer optical reflectors include multiple interleaved or alternating layers of material having a high index of refraction and a material having a low index of refraction at a target wavelength of light to be modulated by the optical modulator. By a high index of refraction (n) it is meant a refraction of from about 2.6 to about 4.0 or more at target wavelengths of from 550 nm to 2 μm (2000 nm). By a low index of refraction (n) it is meant a refraction of from about 1.0 to about 2.0 at the target wavelengths. These alternations of layers having a high index of refraction with layers having a low index of refraction provide high reflectivity at interfaces of the layers. Additionally, both high and low index materials are further selected to have a low absorption (k) at the target wavelength. By a low absorption it is meant a material absorb less than one percent (1%) of light incident on the reflector. Suitable high index materials having a high index of refraction (n) include semiconductors and materials such as monocrystalline silicon (Si), poly-crystalline silicon, amorphous silicon, silicon-nitride, silicon-germanium, silicon-carbide, titanium-oxide (TiO₂) or zirconium-oxide (ZrO₂) Suitable low index materials having a low index of refraction (n) include silicon-dioxide, silicon-nitride, germanium, air or a MEMS fill gas. By a MEMS fill gas it is meant a gas or mixture of gases introduced during manufacture to fill spaces between layers and elements of the MEMS optical modulator, which is then hermetically sealed. The MEMS fill gas can be used to reduce corrosion of materials MEMS optical modulator, increase thermal transfer between layers and elements, and maintain or enhance optical characteristics of the MEMS optical modulator. Suitable fill gases can include pure form or mixtures of one or more of nitrogen, hydrogen, helium, argon, krypton or xenon gases.

Generally, the number of layers in the multilayer optical reflector is selected to be symmetrical about a mid-plane of the reflector, with equal numbers of layers above and below the mid-plane, and to be symmetrical about a neutral axis of the reflector to balance stresses and maintain optical planarity. Thus, the optical reflector can include from three to about twenty-one alternating layers of high and low index material. At a minimum, the high index and low index materials are selected and deposited to ensure that the overall stress stays tensile. Generally, the high index materials and low index material are selected and deposited such that the multilayer optical reflectors may be non-planar at a low, ambient temperature, such as at room temperature, due to differing thicknesses and coefficients of thermal expansion (CTE) of the layers, but become optically planar when raised to an operating temperature of the optical modulator, for example, by a high powered laser or light source.

Additionally, the thicknesses of the high and low index layers are selected or adjusted so as to substantially equal one quarter wavelength of the target wavelength of the light propagating in the material of the layer according to or based on the refractive index of the material.

It is further noted that the material and thickness of a particular layer may, but need not be the same as that of any other layer of high or low index material. By selecting the thicknesses and material of the high index and low index layers, and the number of pairs of layers in the multilayer reflector it is possible to achieve reflectivity of from about 90% to greater than 99%, while providing improved power handling as compared to conventional aluminum reflectors. It is further noted that the power handling is improved by reduced absorption relative to a conventional aluminum reflector, which typically has absorption of 4% or more, and by higher melting temperatures of the high and low index materials, which enables the non-metallic, multilayer reflector to be operated at longer periods at of higher laser fluence. For example, silicon-dioxide has a melting temperature of about 1710° C., while silicon has a melting temperature of about 1414° C. and Germanium has a melting temperature of about 982° C.—all substantially higher than the 660° C. melting temperature of aluminum used in conventional, metallic reflectors.

FIG. 25 is a schematic sectional side view of a stack of layers in a non-metallic, multilayer optical reflector according to one such embodiment. Referring to FIG. 25, in the embodiment shown the non-metallic, multilayer optical reflector 2502 consists of five layers including a lower or first layer 2504 of a high index material having a high index of refraction overlying electrostatically deflectable element 2507 (i.e., a ribbon of a ribbon-type modulator or an actuator of a PLV™), including a mechanical layer 2506 and an electrode layer 2516. A second layer 2508 of a dielectric or low index material having a low index of refraction formed over the first layer 2504, and a third layer 2510 of a high index material having a high index of refraction formed over the second layer. A fourth layer 2512 of a dielectric or low index material having a low index of refraction formed over the third layer 2510, and a fifth layer 2514 of a high index material having a high index of refraction formed over the fourth layer.

Where the electrostatically deflectable element is a ribbon of a ribbon-type modulator or an actuator of a stepped PLV™, such as shown and described with reference to FIGS. 2A to 2C above, first layer 2504 can be formed directly on the mechanical layer 2506 or on an electrode layer 2516 formed on the mechanical layer. In some embodiments, where the first layer 2504 is formed directly on the electrode layer 2516, the electrode layer can further serve or function as an absorber layer.

Alternatively, where the electrostatically deflectable element is an actuator of a PLV™ having a reflector physically separated from the mechanical layer by a center support, as shown and described with reference to FIG. 24, the first layer 2504 can be formed directly on or above a mechanical layer 2506 or electrode layer 2516 of the second optical reflector 2408, and on or above a mechanical layer of the face-plate 2402.

Optionally, by proper selection of the high index material and thickness of the first layer 2504 both the mechanical layer and the first layer of the first reflector 2404 on the face-plate 2402 and second reflector 2410 on the electrostatically deflectable element 2507 or actuator can be formed from a single, taut or tensile silicon-nitride or silicon-germanium layer, which serves or functions as both the mechanical layer 2506 and the first layer 2504 of the multilayer optical reflector 2502 for both the face-plate and the actuator.

In yet another embodiment, the mechanical layer 2506, the electrode layer 2516 and the first layer 2504 of the multilayer optical reflector 2502 can be formed from a single, taut or tensile silicon-germanium layer, which serves or functions as the mechanical layer, the electrode layer and the first layer of the multilayer optical reflector 2502 on the electrostatically deflectable element 2507 or actuator, and the mechanical layer and the first layer of the multilayer optical reflector on the face-plate 2402.

In one version of the above embodiments, the high index material of the first, third and fifth layers include silicon-germanium layers having an index of refraction (n) of about 4.0 at a target wavelength of 850 nm, and thicknesses of about 45 nm. The low index material of the second and fourth layers include silicon-dioxide layers having an index of refraction (n) of about 1.4 at the target wavelength, and a thicknesses of about 146 nm, to provide a reflectance of 99% or greater and an absorption of less than about 1%.

In other embodiments, the low index material is or includes air, and the non-metallic, multilayer optical reflector includes layers of high index material interleaved or separated by air-gaps. FIG. 26 is a schematic sectional side view of a stack of layers in a non-metallic, multilayer optical reflector according to one such embodiment. Referring to FIG. 26, in the embodiment shown the non-metallic, multilayer optical reflector 2602 consists of a lower or first layer 2604 of a high index material having a high index of refraction overlying a mechanical layer of an electrostatically deflectable element (not shown in this figure). A second layer of air or a first air-gap 2606 is formed over the first layer 2604 by a third layer 2608 of high index material formed over and suspended above the first layer. A fourth layer of air or a second air-gap 2610 is formed over the over the third layer 2608 by a fifth layer 2612 of high index material formed over and suspended above the third layer. As with the embodiment of FIG. 24 described above, the first layer 2604 can be formed directly on the mechanical layer and/or an electrode layer of an electrostatically deflectable element, or can physically separate from the mechanical layer by a center support, as shown and described with reference to FIG. 24

The optical reflector can include from three to about twenty-one alternating layers of high index material and air-gaps, where the number of layers in the multilayer optical reflector is selected to be symmetrical about a mid-plane of the reflector, with equal numbers of layers above and below the mid-plane, and wherein the reflector is symmetrical about a neutral axis of the reflector to balance stresses and maintain optical planarity. Generally, as in the embodiment shown the reflector 2602 further includes a number of periodic mechanical connections or posts 2614 between layers of high index material in order to maintain the air-gaps 2606, 2610. The first and second air-gaps can be formed by deposition and subsequent removal of sacrificial layers between the layers of high index material, as explained in greater detail below. The posts 2614 can be composed of the same material as the first, third and fifth layers and are typically formed concurrently with an overlying layer, by patterning the sacrificial layer prior to depositing the high index material.

In one version of this embodiment, the high index material of the first, third and fifth layers include silicon-germanium layers having an index of refraction (n) of about 4.0 at a target wavelength of 850 nm, and thicknesses of about 45 nm, and the air-gaps of the second and fourth layers have an index of refraction (n) of about 1.0 at the target wavelength, and a thicknesses of about 200 nm, to provide a reflectance of 99% or greater and an absorption of less than about 1%.

In addition to the high power handling capabilities of the multilayer optical reflector 2502 of FIG. 25 which it shares, it is noted that because the air-gaps contribute substantially no mass to the optical reflector 2602 of FIG. 26 or to the electrostatically deflectable element, a MEMS-based optical spatial light modulator including the silicon-germanium and air-gap reflector of FIG. 26 can be operated or switched between reflective and non-reflective states at a substantially higher speed than possible with a solid reflector or mirror. Moreover, in those embodiments in which all of the high index layers are made of a single, mono-material the reflector will have an intrinsic planarity, and is not subject to bimorph stress effects, which can arise when dissimilar materials are joined or laminated together to form a stack of layers.

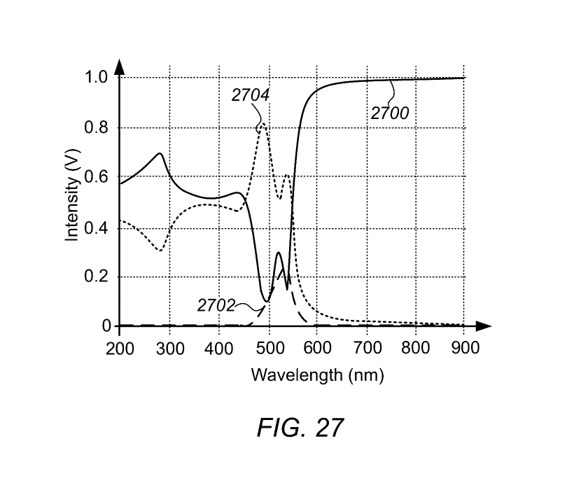

Graphs illustrating the reflection 2700, transmission 2702 and absorption 2704 of a non-metallic, multilayer reflector at visible (VIS) to near-infrared (NIR) wavelengths of from about 600 to 900 nm are shown in FIG. 27. The reflector used in deriving the graphs was substantially the same as that shown in FIG. 26, including three interleaved silicon-germanium layers, each having thicknesses of about 45 nm, and two air-gaps, each having thicknesses of about 200 nm. Referring to FIG. 27 it is seen that a multilayer reflector including three silicon-germanium layers interleaved with or separated by 1^{st} and 2^{nd} air-gaps and having thicknesses noted above exhibits total reflection of greater than about 90% and an absorption of less than about 10% at wavelengths from 550 nm to 900 nm, and a reflection of greater than about 99% and an absorption of less than about 1% at a target wavelengths of 800 nm.

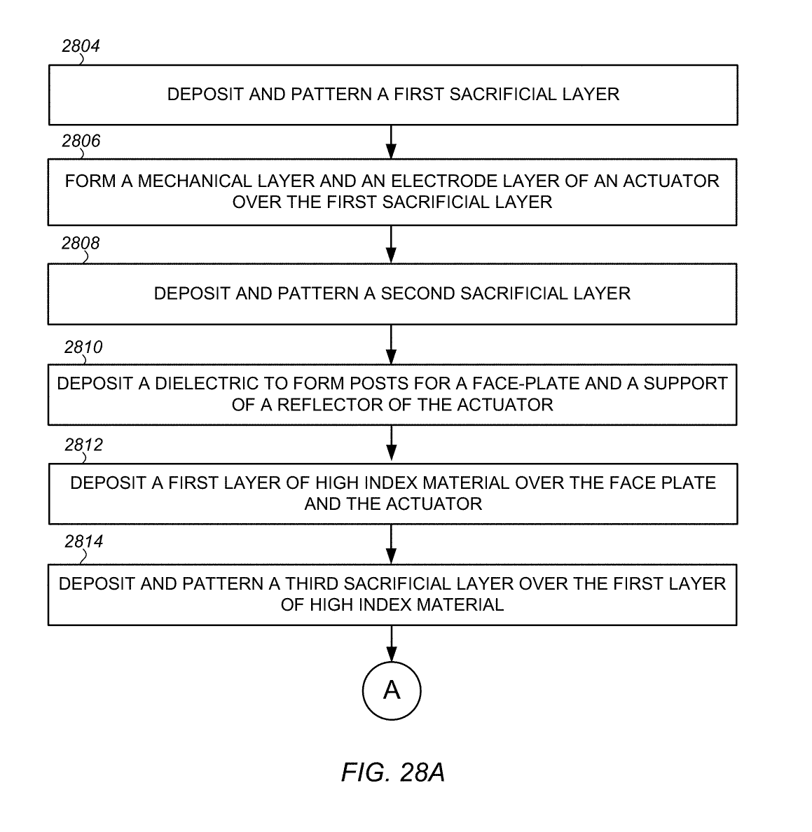

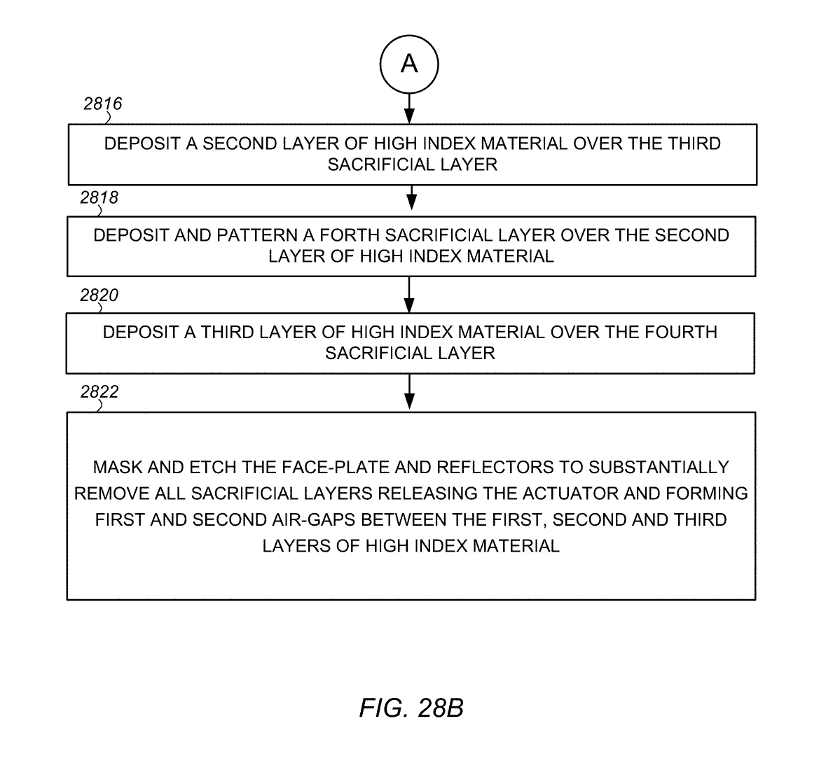

Methods of fabricating an optical modulator including a non-metallic, multilayer optical reflector on an electrostatically deflectable element according to an embodiment of the present disclosure will now be described. In a first embodiment, described with reference to the flowchart of FIGS. 28A and 28B, the optical modulator is a PLV™ type modulator, such as that shown in FIG. 24, the electrostatically deflectable element is an actuator of the PLV™, and the reflector includes a 1^{st} reflector formed on a face-plate of the PLV™ and a 2^{nd} reflector over the actuator. Note the method shown in FIGS. 28A and 28B and described below assumes integrated drive circuitry has already been formed in or on a substrate, and lower electrodes have already been formed underneath the actuators to be formed.

Referring to FIG. 28A, the method begins with the deposition and patterning of a first sacrificial layer over the substrate (2802). The sacrificial layer can include either poly-crystalline silicon or germanium, and is generally deposited to a thickness of about 5/4 a target wavelength in air to avoid a potentially destructive phenomenon commonly referred to as “snap-down” or “pull-in,” in which the actuator snaps into contact with the lower electrode and sticks there even when the electrostatic force is removed. In embodiments in which the high index material of reflector is silicon-germanium the sacrificial layer is germanium. Patterning of the first sacrificial layer includes forming holes for posts to support a mechanical layer of the actuator. Deposition of the first sacrificial layer can be accomplished using chemical vapor deposition (CVD), and the patterning can be accomplished using standard photolithographic techniques and etches.

Next, a mechanical layer of the actuator is formed over the first sacrificial layer by depositing a tensile layer over the first sacrificial layer, filing the holes to form the posts and the mechanical layer of the actuator (2804). The tensile mechanical layer can include silicon-nitride (SiN) or silicon-germanium. Generally, forming the mechanical layer further includes patterning mechanical layer to form flexures as shown in FIG. 2C, and to form an opening for a conductive via through at least one of the posts. However, when silicon-germanium is used as a post material, forming an opening is not necessary as the silicon-germanium post is itself conductive. Deposition of the mechanical layer can be accomplished using CVD, and the patterning can be accomplished using standard photolithographic techniques and etches. A conductive material is then deposited on top of the mechanical layer, to form the electrode layer and fill the opening in the post to form the conductive via electrically connecting the electrode layer to drive circuitry in the substrate (2806) Again, where silicon-germanium is used as the mechanical layer, extra electrode layer is not necessary as silicon-germanium is conductive. To avoid etching the electrode layer in subsequent etches in which overlying layers are patterned, or in the case of sacrificial layers removed, a titanium-nitride (TiN) electrode layer is preferred. Alternatively, when poly-crystalline silicon is used as a sacrificial layer a doped poly-crystalline silicon electrode layer could also be used, but must be encased in by an additional overlying silicon-nitride layer (not shown in FIGS. 25 and 26).

A second sacrificial layer is then deposited over the patterned mechanical layer and electrode layer and patterned (2808). Again the sacrificial layer can include either poly-crystalline silicon or germanium. The thickness of the second sacrificial layer determines a separation between the actuator and face-plate of the optical modulator, thus the thickness will depend on whether the optical modulator is a PLV™ having a co-planar 1^{st} and 2^{nd} reflectors as shown in FIG. 24, or is a stepped PLV™, such as shown in FIG. 2A. Generally, the thickness of the second sacrificial layer is not subject to the quarter (¼) wavelength of the target wavelength as is the first, but can be any arbitrary thickness sufficient to allow a full deflection of the a mechanical layer 2414 and electrode layer 2416. Patterning of the second sacrificial layer includes forming holes for an upper portion of posts to support the face-plate, and optionally a hole for a center support of the actuator. Again the patterning can be accomplished using standard photolithographic techniques and etches.

Next, a first layer of high index material is deposited over the second sacrificial layer to fill the holes for the posts and the center support, and to form a first layer of the reflector over the face-plate and over the center support (2810). The high index material can include silicon, poly-crystalline silicon, silicon-germanium or titanium-oxide (TiOx₂), and is deposited using CVD to a thicknesses selected to equal one quarter wavelength of the target wavelength in the high index material, adjusted according to their refractive index. For example, in one embodiment of the reflector shown in FIG. 26 the first layer of the reflector includes a layer of silicon-germanium having a thickness of about 45 nm.

In those embodiments in which the material of the low index layers in the reflector is air (air-gaps) as shown in FIG. 26, a third sacrificial layer is then deposited over the first layer of high index material and patterned (2814). Again the sacrificial layer can include silicon-germanium. In embodiments in which the high index material of reflector is silicon-germanium the sacrificial layer is germanium. The thickness of the third sacrificial layer determines a thickness of the first air-gap of the reflector, and is generally selected to equal one quarter wavelength of the target wavelength in air. For example, in the embodiment of the reflector shown in FIG. 26 third sacrificial layer is a layer of germanium deposited to a thickness selected to provide a first air-gap of about 200 nm. Patterning of the third sacrificial layer includes forming holes for a number of periodic mechanical connections or posts sparsely placed at a minimum density to hold the reflector together.

Next, a second layer of high index material is deposited over the third sacrificial layer to fill the holes for periodic mechanical connections or posts and to form a third layer of the reflector (2816). The high index material can include silicon, poly-crystalline silicon, silicon-germanium or titanium-oxide (TiOx₂), and is deposited using CVD to a thicknesses selected to equal one quarter wavelength of the target wavelength in the high index material. For example, in one embodiment of the optical modulator shown in FIG. 26 the second layer of high index material is a layer of silicon-germanium, the same as the first layer, to form a mono-material reflector that is not subject to bimorph stress effects, and also has a thickness of about 45 nm.

A fourth sacrificial layer is then deposited over the second layer of high index material (the third layer of the reflector) and patterned (2818). Again the sacrificial layer can include silicon-germanium, and has a thickness equal to one quarter wavelength of the target wavelength in air. In embodiments in which the high index material of reflector is silicon-germanium the sacrificial layer is germanium. For example, in the embodiment of the reflector shown in FIG. 26 the fourth sacrificial layer is a layer of germanium deposited to a thickness selected to provide a first air-gap of about 200 nm. Patterning of the third sacrificial layer includes forming holes for a number of periodic mechanical connections or posts sparsely placed at a minimum density to hold the reflector together.

Next, a third layer of high index material is deposited over the third sacrificial layer to fill the holes for periodic mechanical connections or posts and to form a fifth layer of the reflector (2820). The high index material can include silicon, poly-crystalline silicon, silicon-germanium or titanium-oxide (TiOx₂), and is deposited using CVD to a thicknesses selected to equal one quarter wavelength of the target wavelength in the high index material. For example, in one embodiment of the of the reflector shown in FIG. 26 the third layer of high index material is a layer of silicon-germanium, and has a thickness of about 45 nm.

Finally, a mask is formed over the third layer of high index material (the fifth of top layer of the reflector) and the layers of the reflector etched to form the first reflector on the face-plate and the second reflector over the actuators, to subsequently substantially remove all sacrificial layers releasing the actuators and forming first and second air-gaps of the reflectors between the first, second and third layers of high index material (2822). Generally, etch and release is accomplished in a single wet or dry etch step.

The method of FIGS. 28A and B described above has particular application to the PLV™ of FIG. 24 including a silicon-germanium and air-gap reflector of FIG. 26. However, it will be understood that the method can also be used to a PLV™ having solid dielectric layers, as shown in FIG. 25, by substituting layers of a low index material having a low index of refraction, such as silicon-dioxide or silicon-nitride, having thickness equal to one quarter (¼) of the target wavelength, adjusted according to their refractive index, for the third and fourth sacrificial layers.

Similarly, it will be understood that the method can also be used to form a GLV™ or ribbon-type optical modulator in which the electrostatically deflectable elements are ribbons, and having non-metallic, multilayer reflectors including either solid dielectric layers or air-gaps. In one embodiment, the method for fabricating ribbon-type optical modulator is identical to that described above up to the deposition of the electrode layer, step 2806. Thereafter, the first semiconductor layer, the first layer of the reflector, is formed directly on the electrode layer, step 2812, and the method continues substantially as described above to form reflectors including air-gaps. Alternatively, reflectors having solid dielectric layers, as shown in FIG. 25, can be formed on the ribbons by substituting layers of a material having a low index of refraction, such as silicon-dioxide or silicon-nitride, having thickness equal to one quarter (¼) of the target wavelength for the third and fourth sacrificial layers, again, and adjusted according to their refractive index.

Thus, embodiments of MEMS-based optical modulators with non-metallic, multilayer reflectors and methods of fabricating and using the same have been described. Although the present disclosure has been described with reference to specific exemplary embodiments, it will be evident that various modifications and changes may be made to these embodiments without departing from the broader spirit and scope of the disclosure. Accordingly, the specification and drawings are to be regarded in an illustrative rather than a restrictive sense.

The Abstract of the Disclosure is provided to comply with 37 C.F.R. § 1.72(b), requiring an abstract that will allow the reader to quickly ascertain the nature of one or more embodiments of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

Reference in the description to one embodiment or an embodiment means that a particular feature, structure, or characteristic described in connection with the embodiment is included in at least one embodiment of the circuit or method. The appearances of the phrase one embodiment in various places in the specification do not necessarily all refer to the same embodiment.

What is claimed is:

1. A method of fabricating an optical modulator, comprising:
forming a number of electrostatically deflectable elements over a surface of a substrate, each electrostatically deflectable element including a mechanical layer and an electrode layer; and
forming a non-metallic, multilayer optical reflector over each electrostatically deflectable element, the multilayer optical reflector including at least a first layer comprising a first high index material having a high index of refraction, a second layer comprising a low index material having a low index of refraction formed over the first layer, and a third layer comprising a second high index material having a high index of refraction formed over the second layer.

2. The method of claim 1, wherein forming the number of electrostatically deflectable elements comprises forming a mechanical layer comprising a tensile material, and wherein forming the multilayer optical reflector comprises selecting first and second high index materials, and the low index material are selected and deposited such that the multilayer optical reflector is planar when raised to an operating temperature of the optical modulator.

3. The method of claim 2, wherein the multilayer optical reflector includes from three to twenty-one layers, and wherein forming multilayer optical reflector comprises alternating high and low index materials.

4. The method of claim 3, wherein forming the multilayer optical reflector comprises forming each layer to have a thickness of one-quarter (¼) of a target wavelength of light propagating in the material of the layer.

5. The method of claim 1, wherein the first and second high index materials comprise monocrystalline silicon, poly-crystalline silicon, amorphous silicon, silicon-nitride, silicon-germanium, silicon-carbide, titanium-oxide or zirconium-oxide, and wherein the low index material comprises silicon-oxide, silicon-nitride, germanium, air or a MEMS fill gas.

6. The method of claim 1, wherein the low index material comprises an air gap between the first and third layers, formed by forming and patterning a sacrificial layer on the first layer, forming the third layer on the sacrificial layer and etching the sacrificial layer through openings in a top surface of the third layer, or through side openings between the first and the second layers.

7. The method of claim 1, wherein the optical modulator is a Planar Light Valve (PLV™) and wherein forming the number of electrostatically deflectable elements comprises forming a number of movable actuators, each movable actuator comprising the mechanical layer and electrode layer.

8. The method of claim 7, wherein forming the mechanical layer and forming the first layer of the first high index material comprises forming a single silicon-nitride layer over the electrode layer, and wherein the silicon-nitride layer serves as the mechanical layer and the first layer of the multilayer optical reflector.

9. The method of claim 7, wherein forming the mechanical layer, the electrode layer and the first layer of the first high index material comprises forming a single silicon-germanium layer, and wherein the silicon-germanium layer serves as the mechanical layer, the electrode layer and the first layer of the multilayer optical reflector.

10. The method of claim 7, wherein forming the multilayer optical reflector comprises forming the multilayer optical reflector on a central support formed on each movable actuator, mechanically isolating the multilayer optical reflector from the movable actuator.

11. A method of fabricating an optical modulator, comprising:
depositing a mechanical layer and an electrode layer on a first sacrificial layer over a surface of a substrate;
forming over the mechanical layer and the electrode layer a multilayer optical reflector including at least a first layer comprising a first high index material having a high index of refraction proximal to the mechanical layer and the electrode layer, a second layer comprising a low index material having a low index of refraction formed over the first layer, and a third layer comprising a second high index material having a high index of refraction formed over the second layer; and
patterning the mechanical layer, the electrode layer and the multilayer optical reflector, and removing the first sacrificial layer to form a number of electrostatically deflectable elements;
wherein forming the second and third layers comprise depositing and patterning a second sacrificial layer on the first layer, depositing and patterning the third layer on the second sacrificial layer, and removing the first sacrificial layer comprises removing the second sacrificial layer, and wherein the low index material of the second layer of the multilayer optical reflector comprises air or a MEMS fill gas.

12. The method of claim 11, wherein depositing the mechanical layer and electrode layer, and wherein forming the multilayer optical reflector comprises selecting and depositing materials under conditions such that the multilayer optical reflector is planar when raised to an operating temperature of the optical modulator.

13. The method of claim 11, wherein the first and second high index materials comprise monocrystalline silicon, poly-crystalline silicon, amorphous silicon, silicon-nitride, silicon-germanium, silicon-carbide, titanium-oxide or zirconium-oxide.

14. The method of claim 11, wherein forming the first and third layer comprises forming each layer to have a thickness of one-quarter (¼) of a target wavelength of light propagating in the material of the layer, and wherein forming the second layer comprises depositing the second sacrificial layer to have a thickness of one-quarter (¼) of the target wavelength in air.

15. The method of claim 11, wherein the optical modulator is a Planar Light Valve (PLV™), and wherein forming the mechanical layer and forming the first layer of the first high index material comprises forming a single silicon-nitride layer over the electrode layer, and wherein the silicon-nitride layer serves as the mechanical layer and the first layer of the multilayer optical reflector.

16. The method of claim 11, wherein the optical modulator is a Planar Light Valve (PLV™), and wherein forming the mechanical layer, the electrode layer and the first layer of the first high index material comprises forming a single silicon-germanium layer, and wherein the silicon-germanium layer serves as the mechanical layer, the electrode layer and the first layer of the multilayer optical reflector.

17. An optical modulator comprising:
a number of electrostatically deflectable elements suspended over a surface of a substrate, each electrostatically deflectable element including a mechanical layer and an electrode layer; and
a non-metallic, multilayer optical reflector over each electrostatically deflectable element, the multilayer optical reflector including at least a first layer comprising a first high index material having a high index of refraction, a second layer comprising a low index material having a low index of refraction formed over the first layer, and a third layer comprising a second high index material having a high index of refraction formed over the second layer,
wherein the second layer of the multilayer optical reflector comprises a gap between the first layer and the third layer, and wherein the low index material of the second layer comprises air or a MEMS fill gas.

18. The optical modulator of claim 17, wherein the first and second high index materials comprise monocrystalline silicon, poly-crystalline silicon, amorphous silicon, silicon-nitride, silicon-germanium, silicon-carbide, titanium-oxide or zirconium-oxide.

19. The optical modulator of claim 17, wherein materials of the mechanical layer, the electrode layer and the multilayer optical reflector are selected and deposited under conditions such that the multilayer optical reflector is planar when raised to an operating temperature of the optical modulator.

20. The optical modulator of claim 17, wherein the optical modulator is a Planar Light Valve (PLV™), and wherein the mechanical layer, the electrode layer and the first layer of the first high index material comprise a single silicon-germanium layer that serves as the mechanical layer, the electrode layer and the first layer of the multilayer optical reflector.
